(19) United States
(12) Patent Application Publication
(10) Pub. No.: US 2009/0113179 A1
(43) Pub. Date: Apr. 30, 2009

(54) OPERATIONAL PROCESSING APPARATUS, PROCESSOR, PROGRAM CONVERTING APPARATUS AND PROGRAM

(75) Inventors: Masahide KAKEDA, Hyogo (JP); Shinji OZAKI, Osaka (JP); Takao YAMAMOTO, Osaka (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/259,589

(22) Filed: Oct. 28, 2008

(30) Foreign Application Priority Data
Oct. 29, 2007 (JP) 2007-281018

(51) Int. Cl. G06F 9/312

(52) U.S. Cl. 712/205; 712/214; 712/E09.033

(57) ABSTRACT

The present invention provides an operational processing apparatus which can guarantee a period for executing instructions in the shortest cycle when the operational processing apparatus synchronizes with a hardware accelerator. A processor in the present invention simultaneously issues and executes instructions including instruction groups having a simultaneously issueable instruction. The processor executes a program including a specific instruction. The specific instruction instructs to exclude an instruction subsequent to the specific instruction out of the instruction groups including the specific instruction, and to suspend issuing the instruction subsequent to the specific instruction only during a predetermined period immediately after the specific instruction is issued.

### BACKGROUND OF THE INVENTION

(1) Field of the Invention

The present invention relates to operational processing apparatuses which can execute plural instructions in a cycle and in particular, relates to an effective technique of processing, synchronizing with a hardware accelerator.

(2) Description of the Related Art

Recently, processing performance has been significantly improved thanks to parallelization techniques based on superscalar, a multi-processor, and a multi-thread architecture, as well as a super pipeline technique. On the other hand, demands are increasing for real time processing which is subject to unfailing completion, within a certain period of time, of processing toward a hardware accelerator and a request from a program.
Patent Reference 1: Japanese Unexamined Patent Application Publication No. 09-54693 (FIG. 1)
Non-patent Reference 1: John L. Hennessy & David A. Patterson “Computer Architecture A Quantitative Approach Fourth Edition” 2006 as (P. 172 Chapter Three Limits on Instruction-Level Parallelism)

### SUMMARY OF THE INVENTION

A processor with the parallelization techniques applied to, however, fails to have a mechanism to easily guarantee a real time processing performance in real time processing involving an access to a hardware accelerator. Thus, assurance of the real time processing performance requires either a processor with enough processing capability, or a processor on which an estimate of an application performance is executable. Here, the application performance is assumed to cope with unlikely worst-case scenarios (processor loading, memory access contention, and other pipeline hazards). For example, there is a scheme of a processor waiting the real time processing to be completed in a pipe line stall state while executing a load/store access. The scheme secures the processor to operate in the shortest time period since an access to the hardware accelerator by the processor can synchronize with completion of processing by the hardware accelerator. Meanwhile, the scheme causes a problem of implementation regarding a speed path in a micro architecture of a is processor having a high-speed super pipeline mechanism, since the scheme requires an interlock mechanism for the pipeline control. Further, there is another scheme of synchronizing by the processor and the hardware accelerator, using an interrupt or the Corse Grain Multithreading (CGMT) mechanism (see Patent Reference 2: Japanese Unexamined Patent Application Publication No. 2003-271399 (FIG. 1)). In a view point of surely avoiding the worst-case scenarios in the real time processing, the scheme has a problem as a mechanism of the processor timing (synchronizing) with granularity of plural cycles up to plural tens of cycles, since overhead on process switching has large granularity. Finally, a timing adjustment scheme utilizing a branch instruction, a pipeline re-start execution on a load/store access, or the NOP instruction insertion is a suitable mechanism for the timing (the synchronizing) at the smallest granularity. The timing adjustment scheme, however, increases number of the NOP instructions and requires code changes according to the operating frequency. Moreover, a super-pipelined processor with the simultaneous multithreading (SMT) mechanism has a problem that adjustment of the granularity can be difficult even though the branch instruction, the pipeline re-start execution on a load/store access, and the NOP instruction insertion are utilized under the worst case scenarios: U.S. Pat. No. 5,958,044 (FIG. 1) The super-pipelined processor with the SMT mechanism in the third problem is in operation on the condition that the processor executes as many instructions as possible. Thus, as many NOP instructions as the number of the instructions assumed to be executed are required to be inserted. Specifically, when the SMT is executed, an instruction stream of another thread is possibly executed, and thus, the instruction stream of the thread is unexecuted in every cycle. Therefore, a new problem of adjustable granularity occurs in that the number of the NOP instructions with the worst-case scenarios estimated causes to have too much actual time.

As mentioned above, when a multi-threaded processor with super-pipeline accesses a hardware accelerator, a scheme needs to be considered in order to guarantee an actual time for an instructions execution in the shortest cycles of smallest granularity on a cycle-time basis.

The present invention has as an objective to provide a multi-threaded and pipelined operational processing apparatus which can guarantee a period for executing instructions in the shortest cycle, regardless of an instruction issuance state, of each thread, for each cycle, when the operational processing apparatus synchronizes with a hardware accelerator.

In order to solve the above problems, an operational processing apparatus, in the present invention, which can execute instructions in a same cycle includes: an instruction fetching unit fetching instruction codes; an instruction issuing unit dividing the instruction codes fetched by the instruction fetching unit into at least one instruction group which includes one or more simultaneously issueable instruction codes, and issue one or more instruction codes in the at least one instruction group; an instruction decoding unit decoding the one or more instruction codes issued by the instruction issuing unit, and generate control signals required for operation; and an operation processing unit performing operation according to the control signals generated by the instruction decoding unit, wherein the instruction issuing unit includes: a detecting unit configured to detect a specific instruction instructing to suspend issuing instruction codes subsequent to the specific instruction during a predetermined period of cycles immediately after the specific instruction is issued; and an instruction issuance suspending unit suspending issuing of the instruction codes subsequent to the specific instruction during the predetermined period immediately after the specific instruction is issued.

Here, in the case where the specific instruction is detected, the instruction issuing unit may exclude instruction codes subsequent to the specific instruction out of an instruction group including the specific instruction.

Here, the instruction fetching unit may fetch instruction codes for each of a plurality of threads, and the instruction issuing unit may divide fetched instruction codes into instruction groups for each of the plurality of threads.

It is noted that, in the present invention, an instruction synchronous execution is to adjust the shortest program execution time in a program execution time of an SMT-executable processor.

Here, the detecting unit may detect the specific instruction by a one-bit instruction bit field included in each of instruction codes. According to the structure, the operational processing apparatus in the present invention includes a unit, enabling a real-time execution to all the instructions, which detects the instruction synchronous execution by a one-bit instruction bit field in instruction codes.

Here, the detecting unit may detect the specific instruction by decoding an instruction bit field having bits included in each of instruction codes. According to the structure, the operational processing apparatus in the present invention includes a unit, enabling to perform a real-time execution to a specific instruction, which detects the instruction synchronous execution by decoding an instruction bit fields.

Here, the detecting unit may detect first and second instructions by decoding an instruction bit field having bits included in each of instruction codes, and may detect each of instructions between the first instruction and an instruction immediately before the second instruction as the specific instruction. Here, the operational processing apparatus may further include a processor state register which holds a state signal showing that issuing of the instruction codes subsequent to the specific instruction is currently suspended. According to the structure, the operational processing apparatus in the present invention includes a unit, decoding instruction bit fields to detect validity and invalidity of the instruction synchronous execution, which manages a state in which the operational processing apparatus is real-time executable.

Here, the holding unit may disable the state signal held in the holding unit when interruption processing is occurred. According to the structure, the operational processing apparatus in the present invention includes a unit, decoding instruction bit fields to detect validity and invalidity of the instruction synchronous execution, and detecting invalidation when receiving interruption, which manages a state in which the operational processing apparatus is the real-time executable, and cancels the state when an enough time for the real-time execution is elapsed thanks to the interruption processing.

Here, the instruction issuance suspending unit may include a number of cycles storing unit storing the number of cycles showing the predetermined period of cycles, and the operational processing apparatus may suspend issuing the instruction subsequent to the specific instruction as long as a period of the number of the stored cycles. According to the structure, the operational processing apparatus in the present invention can effect real-time executable granularity, since including a unit to suspend issuing the instruction in a period of a predetermined number of cycles. The operational processing apparatus in the present invention can change the real-time granularity, since including a unit to suspend issuing the instruction, using software, in a period of the number of cycles set.

Here, the number of cycles storing unit may store the number of cycles corresponding to operating frequency of the operational processing apparatus. According to the structure, the operational processing apparatus in the present invention can effect real-time executable granularity regardless of operating frequency, since as including a unit to suspend issuing the instruction in a period of a predetermined number of cycles based on setting of a predetermined operating frequency of the processor.

Here, the number of cycles storing unit may store the numbers of cycles corresponding to each of operating frequencies on which the operational processing apparatus can be operated. According to the structure, the operational processing apparatus in the present invention can change the real-time executable granularity regardless of operating frequency, since including a unit to suspend issuing the instruction in a period of the number of cycles set by software based on setting of a predetermined operating frequency of the processor.

Here, the instruction issuing unit may include an operation mode detecting unit detecting whether or not the operational processing apparatus is in a prioritized operation mode in which a thread to which the specific instruction belongs has priority over another thread, and the instruction issuance suspending unit may suspend issuing the instruction subsequent to the specific instruction, based on the detected operation mode, as long as the predetermined period of cycles. According to the structure, the operational processing apparatus in the present invention can effect real-time executable granularity even though a real-time processing performance is guaranteed to the operational processing apparatus, since including a unit to suspend issuing the instruction in a period of the number of cycles based on setting of a performance guarantee on an SMT execution.

Here, the instruction issuing unit may include: an operation mode detecting unit detecting whether or not the operational processing apparatus is in an operation mode in which a thread to which the specific instruction belongs has priority over another thread; and a number of cycles storing unit storing the number of cycles showing the predetermined period of cycles for each of operating modes, and the instruction issuance suspending unit may suspend issuing the instruction subsequent to the specific instruction as long as a period corresponding to the number of cycles based on the detected operation mode. According to the structure, the operational processing apparatus in the present invention can change the real-time granularity even though a real-time processing performance is guaranteed to the operational processing apparatus, since including a unit to suspend issuing the instruction in a period of the number of cycles set by software based on setting of a performance guarantee on an SMT execution.

Here, the instruction issuing unit may include a number of instruction storing unit storing the number of issueable instructions between the first and the second instructions, and count down the number for each issuance of an instruction.

Here, the operational processing apparatus may further include: a processor state register which holds a value of the state signal held in the holding unit, wherein the instruction issuance suspending unit may include a number of instructions storing unit storing the number of issueable instructions between the first and the second instructions, and counting down for each issuance of an instruction when the holding unit holds the state signal showing that the issuance of the instruction subsequent to the specific instruction is currently suspended. According to the structure, the operational processing apparatus in the present invention can control the number of instructions to be issued without generating a dummy instruction unnecessarily occupying an instruction slot by allowing the number of issurable instructions to be set during the instruction synchronous execution mode.

In addition, a program converting apparatus, converting a first program into a second program, includes: an extracting unit extracting, from the first program, a directive directing the program converting apparatus setting of a specific instruction; a detecting unit detecting, according to the directive in the first program, a first instruction requesting an external apparatus to perform processing, and second instruction reading a response from the external apparatus; and a generating unit generating the second program by setting the specific instruction between the first and the second instructions, wherein the specific instruction instructs to exclude an instruction subsequent to the specific instruction out of an instruction group including the specific instruction, and to suspend issuing the instruction subsequent to the specific instruction only during a predetermined period immediately after the specific instruction is issued. According to the structure, the program converting apparatus in the present invention can insert a program of which thread can be processed in advance in an instruction synchronization executing mode can be inserted when a directive (including programs) is inserted into a C language program.

Further, a processor in the present invention simultaneously issues and executes instructions including instruction groups having a simultaneously issueable instruction, wherein the processor executes a program including a specific instruction, and the specific instruction instructs to exclude an instruction subsequent to the specific instruction out of the instruction groups including the specific instruction, and to suspend issuing the instruction subsequent to the specific instruction only during a predetermined period immediately after the specific instruction is issued.

Here, the processor may be a multi-thread processor fetching threads and dividing a sequence of instructions into the instruction groups for each of threads.

The effect of the present invention is to guarantee the shortest execution time of an instruction execution time of the thread based on an assignment of multi-thread execution performance, regardless of an instruction execution state of each of threads.

### FURTHER INFORMATION ABOUT TECHNICAL BACKGROUND TO THIS APPLICATION

The disclosure of Japanese Patent Application No. 2007-281018 filed on Oct. 29, 2007 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a functional block diagram exemplifying a structure of an operational processing apparatus in a first embodiment;

FIG. 2 exemplifies a bit structure of an instruction code;

FIG. 3 is a block diagram showing a structure for one thread in an internal structure of an instruction synchronous execution detecting unit in FIG. 1;

FIG. 4 is a diagram showing an internal structure of a register group described in FIG. 1;

FIG. 5 is a block diagram showing a structure of an instruction issuance suspending unit for one thread;

FIG. 6 is a diagram exemplifying a program of Thread A (Program A-1) in a conventional art presented for a comparative explanation;

FIG. 7 is a diagram exemplifying a program of Thread A (Program A-2) in the embodiment;

FIG. 8 is a diagram exemplifying a program (Program B-1) executed along with Thread A;

FIG. 9 is a diagram exemplifying a program (Program C-1) executed along with Thread A;

FIG. 10 is an operational explanatory diagram when the programs A-1, B-1, and C-1 are executed;

FIG. 11 is an operational explanatory diagram when the programs A-1, B-1, and C-1 are simultaneously multi-threaded;

FIG. 12 is a block diagram showing a structure of a modification example of a processor;

FIG. 13 is a block diagram showing a structure for one thread in an internal structure of an instruction synchronous execution detecting unit in a second embodiment;

FIG. 14 is a block diagram showing a structure for one thread in is an internal structure of an instruction synchronous execution detecting unit in the second embodiment;

FIG. 15 is a diagram exemplifying a program (Program A-3) of Thread A;

FIG. 16 is a diagram exemplifying a program of Thread A (Program A-4) in a third embodiment;

FIG. 17 is a block diagram showing a structure for one thread in an internal structure of an instruction synchronous execution detecting unit in a fourth embodiment;

FIG. 18 is a diagram exemplifying a program of Thread A (Program A-5) in the fourth embodiment;

FIG. 19 is a block diagram showing a structure for one thread in an internal structure of an instruction synchronous execution detecting unit in a fifth embodiment;

FIG. 20 is a block diagram showing a structure of an instruction issuance suspending unit for one thread in a sixth embodiment;

FIG. 21 is a block diagram showing a structure of an instruction issuance suspending unit for one thread in a seventh embodiment;

FIG. 22 is a block diagram showing a structure of an instruction issuance suspending unit for one thread in an eighth embodiment;

FIG. 23 is a block diagram showing a structure for one thread in an internal structure of an instruction synchronous execution detecting unit in a ninth embodiment;

FIG. 24 is a block diagram showing a structure for one thread in the internal structure of the instruction synchronous execution detecting unit;

FIG. 25 is a diagram exemplifying a program (Program A-6) of Thread A;

FIG. 26 is a block diagram showing a structure of a program converting apparatus in a tenth embodiment; and

FIG. 27 is a diagram exemplifying a source program (Program D-1) of Thread A.

### DESCRIPTION OF THE PREFERRED EMBODIMENTS

Embodiments of the present invention shall be described with reference to the drawings, hereinafter.

### First Embodiment

An operational processing apparatus in the embodiment is a processor simultaneously issuing and executing instructions constituting a group of instructions including simultaneously issueable instructions. A program executed on the processor includes a specific instruction. Here, the specific instruction provides an instruction to exclude an instruction, subsequent to the specific instruction, out of a group of instructions including the specific instruction; and suspend issuing the instruction subsequent to specific instruction only during a predetermined period immediately after the specific instruction is issued.

The following describes the case where the processor is a multi-threaded processor fetching threads and dividing, for each of the threads, a sequence of instructions into groups of instructions. The multi-threaded processor as an example of the embodiment can simultaneously execute three threads and issue up to three instructions for each thread. Here the instructions which can be simultaneously issued are assumed to be instructions of two threads, and the number of the instructions to be issued is up to four.

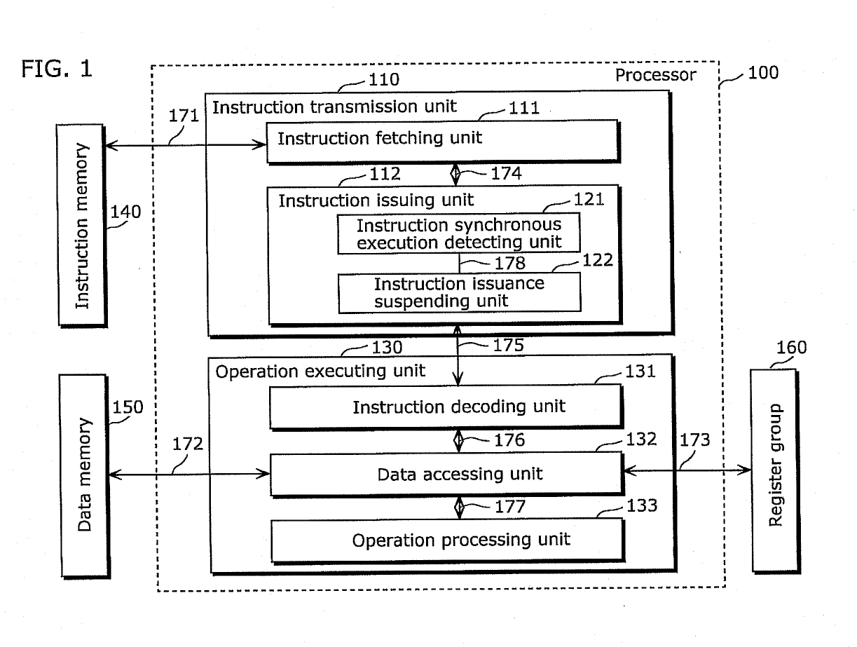

FIG. 1 is a functional block diagram exemplifying a structure of the operational processing apparatus in the first embodiment. In FIG. 1, the operational processing apparatus; namely a processor 100, is includes an instruction transmission unit 110, an operation executing unit 130, an instruction memory 140, a data memory 150, a register group 160. The instruction transmission unit 110 is connected to the instruction memory with a bus 171, and to the executing unit 130 with a bus 175. The operation executing unit 130 is connected to: the instruction transmission unit 110 with a bus 175; the data memory 150 with a bus 172; and the register group 160 with a bus 173.

The instruction transmission unit 110 includes an instruction fetching unit 111 and an instruction issuing unit 112. The instruction fetching unit 111 reads either instructions written as a program, or instructions with addresses to be decided based on interrupted processing due to a hardware control. The instruction issuing unit 112: performs detecting pipeline hazard in the operation executing unit 130, detecting operation resource conflict between the threads, and arbitrating instruction issuance between the threads; and then issues one or more instruction codes to the executing unit 130.

The instruction issuing unit 112 includes an instruction synchronous execution detecting unit 121 and an instruction issuance suspending unit 122. The instruction synchronous execution detecting unit 121 detects whether or not the instruction should be executed by synchronizing the operational processing apparatus of the present invention with a hardware accelerator. The instruction suspending unit 122 generates one of signals for suspending instruction issuance according to an output from the instruction synchronous execution detecting unit 121. It is noted that the detection information obtained by the instruction synchronous execution detecting unit 121 is also used as a condition for dividing an instruction issuance group in the thread. The condition may be an instruction code valid bit in an instruction buffer, described hereinafter.

The operation executing unit 130 receives, from the instruction transmission unit 110, at least one group of instructions, of threads, of which instructions can be executed in a same cycle. The operation executing unit 130 includes an instruction decoding unit 131, a data accessing unit 132, and an operation processing unit 133. The instruction decoding unit 131 generates control signals and data required for the operation in the operation executing unit 130. The data accessing unit 132 accesses the data, based on the control signals and the data generated by the instruction decoding unit 131. The operation processing unit 133 executes the operation, using the control signals and the data generated by the instruction decoding unit 131 and the data accessing unit 132. Further, the data accessing unit 132 is connected to the data memory 150 and the register group 160 including various registers needed for the processor. In the embodiment, it is assumed that the processor is structured for the SMT, which can execute three threads. Thus, the number of internal resources in the processor corresponds to as many as three threads.

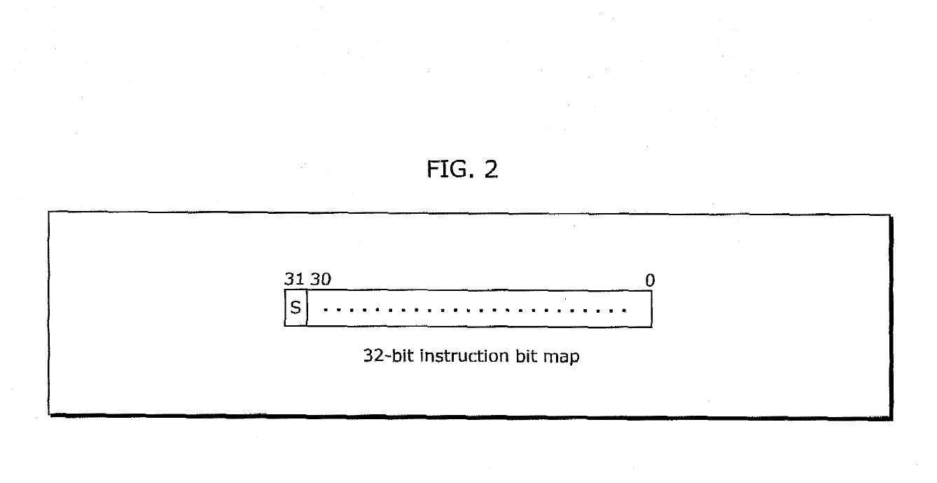

FIG. 2 exemplifies a bit structure of the instruction code. The embodiment exemplifies a 32-bit length fixed instruction bit map, showing that the instruction code is the specific instruction for synchronization with the hardware accelerator when S of a bit 31 is 1. Here, the specific instruction provides an instruction to: exclude an instruction subsequent to the specific instruction out of the group of instructions including the specific instruction; and suspend issuing the instruction subsequent to specific instruction only during a predetermined period immediately after the specific instruction is issued. As shown in FIG. 2, whether or not an instruction is the specific instruction is determined by the bit 31. Thus, all the instructions can be the specific instruction in the embodiment. It is noted, however, that an assignment scheme of bits is not limited to this.

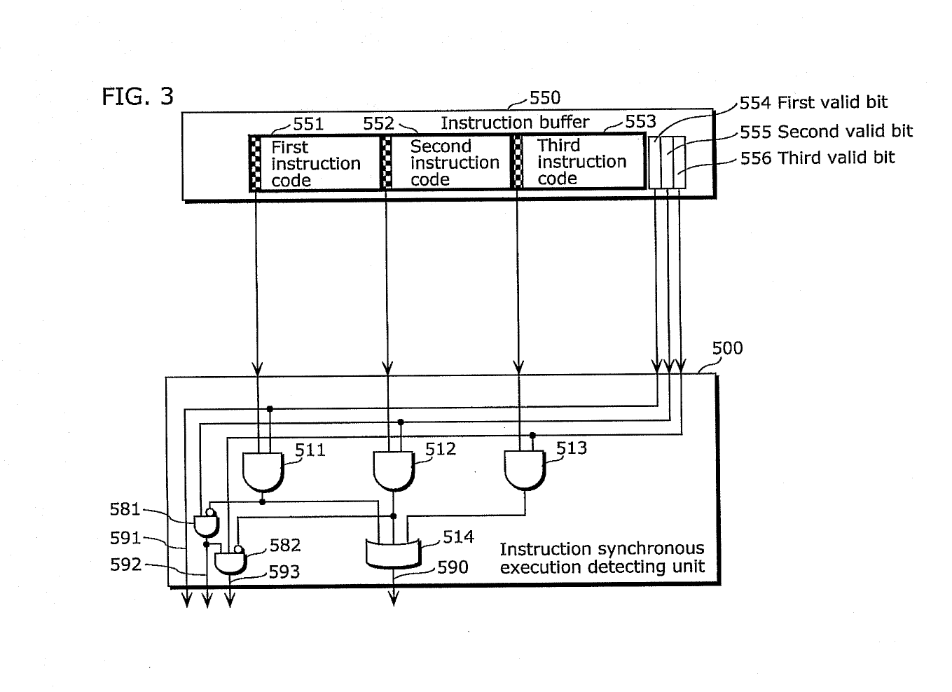

FIG. 3 is a block diagram showing a structure for one thread in an internal structure of the instruction synchronous execution detecting unit 121 in FIG. 1. In a multi-threaded processor simultaneously executing three threads, the instruction synchronous execution detecting unit 121 in FIG. 1 is intended for including three sets of the structure in FIG. 3.

The instruction issuing unit 112 includes an instruction buffer 550 which stores, for each thread, the instructions up to the largest number of instructions to be issued. The instruction buffer 550 stores: a first instruction code 551, a second instruction code 552, and a third instruction code 553 pointed by the order of program addresses in the program counter. The instruction buffer 550 also stores a first valid bit 554, a second valid bit 555, and a third valid bit 556, showing whether or not an effective instruction is stored in the three buffers including the instruction buffer 550.

The instruction synchronous execution detecting unit 500, which receives the above information as inputs, includes an AND gate 511, an AND gate 512, an AND gate 513, and an OR gate 514. The AND gate 511 receives the bit 31 and the first valid bit 554 in the first instruction code 551 as inputs. The AND gate 512 receives the bit 31 and the second valid bit 555 of the second instruction code 552 as inputs. The AND gate 513 receives the bit 31 and the third valid bit 556 of the third instruction code 553 as inputs. The OR gate 514 receives outputs from the AND gate 511, the AND gate 512, and the AND gate 513 as inputs. The instruction synchronous execution detecting unit 500 detects the above specific instruction which needs synchronous execution by each one-bit instruction bit field in the first, second, and the third instruction codes, respectively. As an output from the OR gate 514, an instruction synchronous execution detecting signal 590 is generated. The instruction synchronous execution detecting signal 590 indicates the fact an instruction for which synchronous execution is required is generated.

Further, a first instruction code valid bit 591, a second instruction code valid bit 592, and a third instruction code valid bit 593 are generated. The first instruction code valid bit 591 is directly outputted as the first valid bit 554 in order to indicate whether or not an instruction stored in the instruction buffer 550 can be eventually issued according to the instruction synchronous execution detecting signal 590. The AND gate 581 receives the second valid bit 555 and an inverted output from the AND gate 511 as inputs, and outputs the second instruction code valid bit 592. The AND gate 582: receives the third valid bit 556, the output from the AND gate 581, and an inverted output from the AND gate 512 as inputs; and outputs the third instruction valid bit 593. When the specific instruction is detected, the above mentioned AND gates 511 to 513, 581, and 582 exclude an instruction subsequent to the specific instruction out of the group of instructions including the specific instruction. In other words, an valid bit corresponding to the instruction subsequent to the specific instruction is invalidated as the second instruction code valid bit 592, and the third instruction code valid bit 593.

As described the above, the instruction synchronous execution detecting signal 590 outputted from the instruction synchronous execution detecting unit 500 indicates that the specific instruction for performing synchronization is included in the group of instructions, and the first instruction code valid bit 591, the second instruction code valid bit 592, and the third instruction code valid bit 593 exclude the instruction subsequent to the specific instruction out of the group of instructions including the specific instruction in the thread.

It is noted that the instruction synchronous execution detecting unit 500 in FIG. 3 shows control signals in only one thread. Since a processor simultaneously executable three threads is assumed in the embodiment, the resources for the threads are required for each of the threads. The structure of the processor is obvious from a viewpoint of a processor having an SMT-executable structure; therefore, the description of the structure shall be omitted hereinafter.

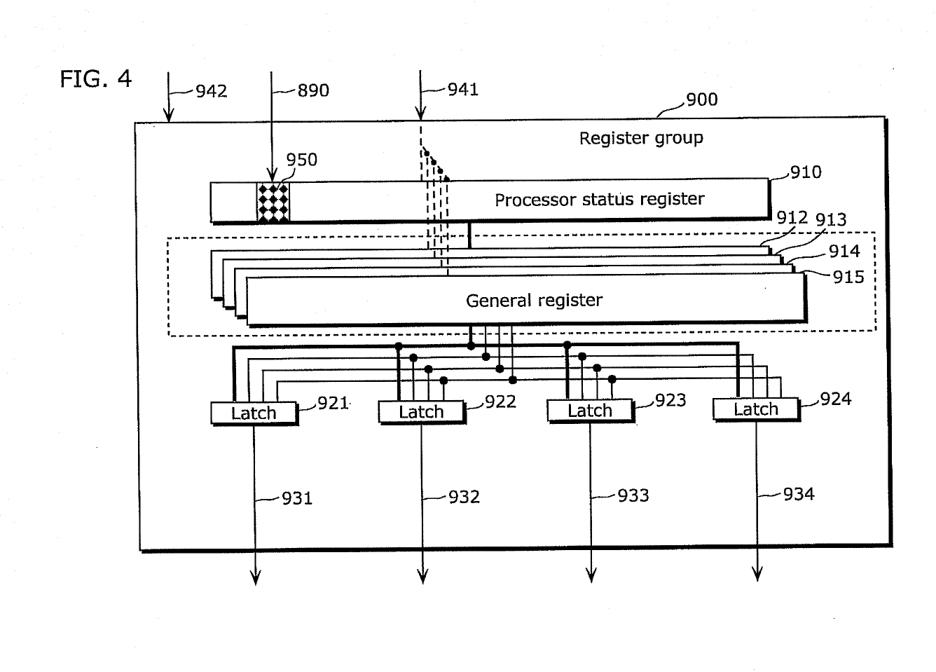

FIG. 4 shows an internal structure of a register group 900 as an example of the register group 160 described in FIG. 1. The register group 900 includes general registers 912 to 915, a processor state register 910 storing a processor state, and operand data latches 921 to 924. The register group 900 also includes a flag register storing a flag showing an operational result, and a control register required for the processor. It is noted that these resources are required for each of the threads. The structure of register groups for SMT is obvious from a viewpoint of the processor having an SMT-executable structure; therefore, the description of the structure shall be omitted hereinafter.

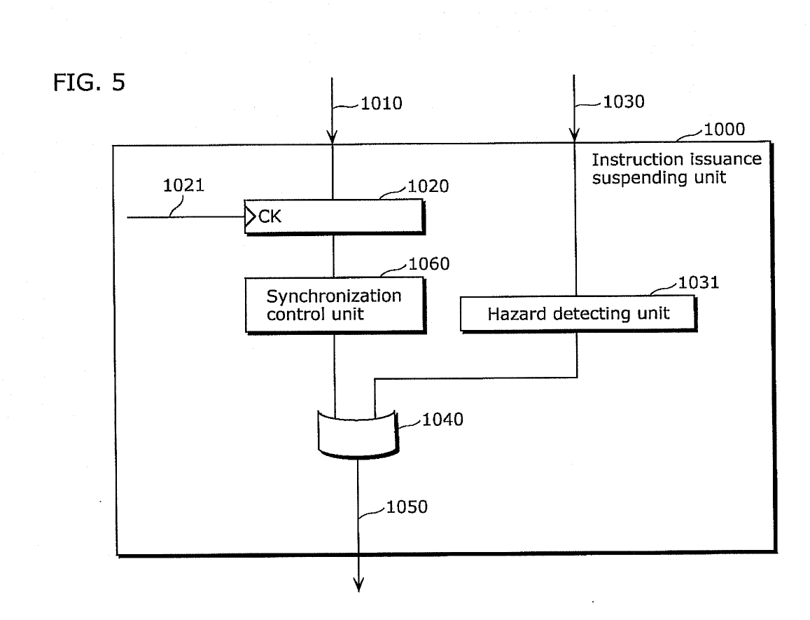

FIG. 5 is a block diagram showing a structure of an instruction issuance suspending unit 1000 corresponding to one thread in the internal structure of the instruction issuance suspending unit 122 described in FIG. 1. The instruction issuance suspending unit 1000 receives an instruction issuance suspending requesting signal 1010 and a pipeline hazard state signal 1030 as inputs. The instruction issuance suspending requesting signal 1010 is obtained from the instruction synchronous execution detecting signal 590 outputted from the instruction synchronous execution detecting unit 500. The pipeline hazard state signal 1030, which relates to pipeline hazard, is obtained from the instruction issuing unit 112 and the operation executing unit 130.

The instruction issuance suspending unit 1000 includes a flip-flop 1020, a synchronization control unit 1060, a hazard detecting unit 1031, and an OR gate 1040. The flip-flop 1020 receives, as inputs, the instruction issuance suspending requesting signal 1010, and a clock signal 1021 used in the instruction transmission unit 110. The synchronization control unit 1060 is a state machine receiving an output from the flip-flop 1020 as an input, and generating a signal which shows an instruction issuance suspending period. The synchronization control unit 1060 outputs an instruction issuance suspension state signal 1050 providing an instruction for suspending issuance of an instruction subsequent to the specified instruction only during a predetermined period immediately after the issuance of the above specified instruction. The predetermined period may be preliminarily fixed, such as for two cycles and three cycles.

As described above, the instruction issuance suspension state signal 1050, outputted from the OR gate 1040, is generated as an output signal from the instruction issuance suspending unit 1000, and thus, a signal is generated out of the instruction issuance suspension state signal 1050, the signal indicating the issuance of an instruction of the thread in the next cycle to be impossible.

It is noted that the instruction issuance suspending unit 1000 in FIG. 5 shows only control signals in the thread. Since a processor simultaneously executable three threads is assumed in the embodiment, the resources for the threads are required for each of the threads. The structure of the instruction issuance suspending units for SMT is obvious from a viewpoint of a processor having an SMT-executable structure; therefore, the description of the structure shall be omitted hereinafter.

It is noted that the internal structures of the instruction transmission unit 110 and the operation executing unit 130 are described in the embodiment; meanwhile, the orders of the processing can be switched according to a structure of a pipeline, and thus, shall not be limited to this.

As mentioned above, with the instruction issuing unit 121 included, the processor 100 can provide an operational processing apparatus capable of: executing the SMT; and adjusting the shortest time of the execution time of a program corresponding to the thread with the smallest granularity regardless of execution states of other threads. Here, the instruction issuing unit 121: pre-decodes the instruction codes indicating that the operational processing apparatus synchronizes with a hardware accelerator; and performs instruction issuing control with a logical OR of the pipeline hazard signal 1030 and the instruction issuance suspending requesting signal 1010. The pipeline hazard state signal 1030 is required for an ordinary processor for each of the threads. The instruction issuance suspending requesting signal 1010 is generated by the instruction regardless of the pipeline hazard.

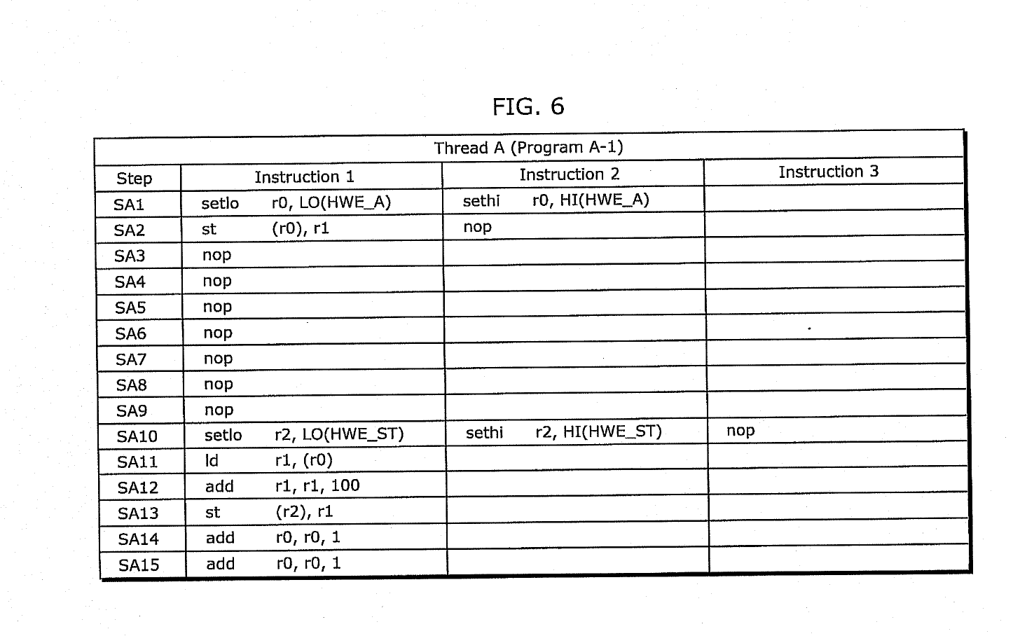

Programs described in the embodiment and operational examples thereof shall be described hereinafter, with reference to program examples shown in FIGS. 6 to 9 and FIGS. 10 and 11 showing an instruction execution state for each of the threads.

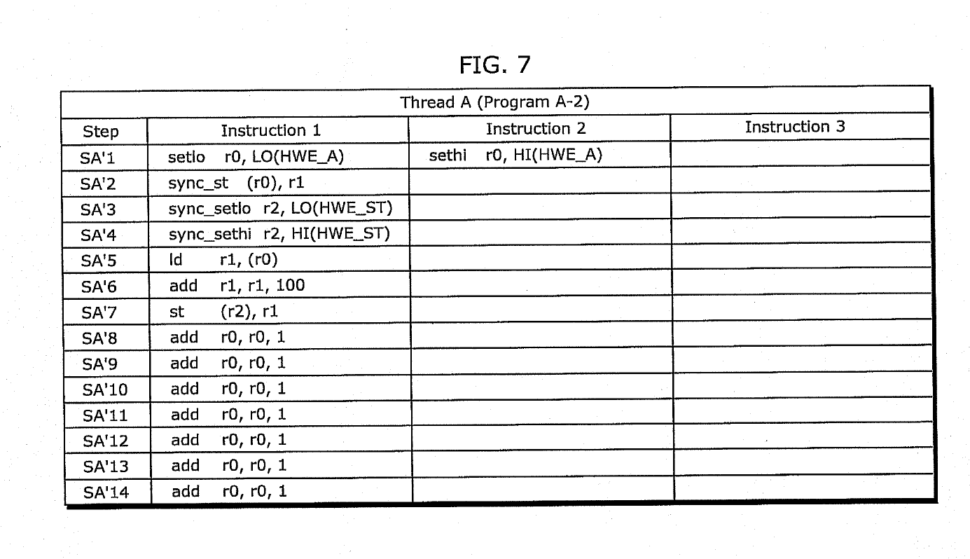

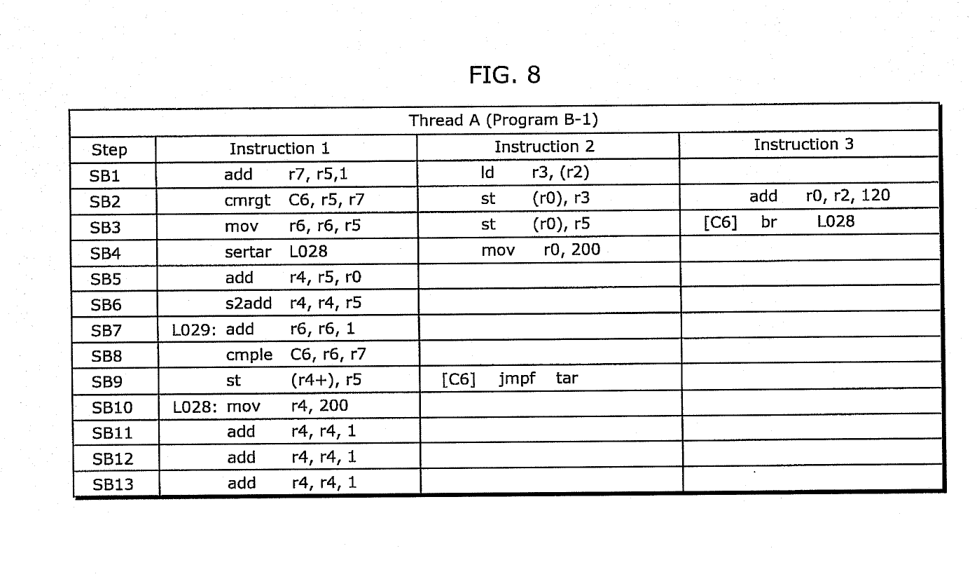

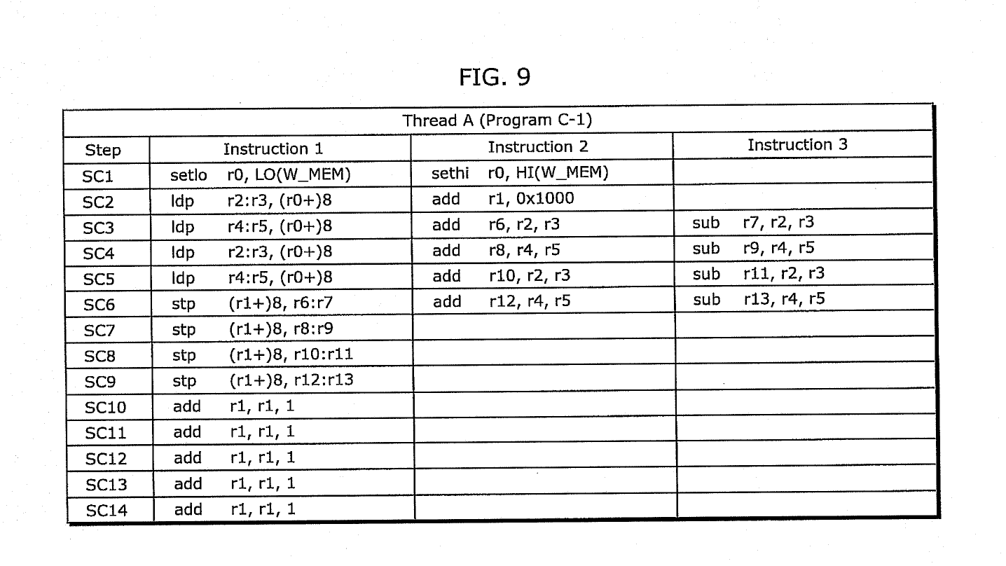

A program A-1 shown in FIG. 6 is a program example, of Thread A, describing a problem with a conventional art which does not utilize the embodiment, and an effect of the first embodiment. A program A-2 shown in FIG. 7 is a program example, of Thread A, in the case where the embodiment is utilized. Programs B-1 and C-1 described in FIGS. 8 and 9 are program examples of Threads B and C executed when Thread A is on operation.

The program A-1 in FIG. 6 describes a group of instructions, included in Thread A, issued by the instruction issuing unit 112. In the STEP column, execution steps SA1, SA2, . . . SA15 are described in the order of each of the execution step cycles.

Regarding instructions to be issued in a same cycle of each of the threads, just one load/store instruction can be issued, and three instructions can be issued for an operational and logic instruction and a transfer instruction. In SA1, a setlo instruction and a sethi instruction can be issued. The setlo instruction is for storing, into a register r0, the lower 16 bits of immediate 32 bits (HWE_A). The sethi instruction is for storing, into the register r0, the higher 16 bits of the immediate 32 bits (HWE_A). The subsequent st instruction becomes issueable in SA2 for hazard evasion for the group of instructions in SA1. The instructions in SA2 include an instruction for storing the content of a register r1 into memory addressed by r0, and a nop instruction. The instructions in SA3 through SA9 are nop instructions. Similar to SA1, SA10 includes an instruction for storing immediate 32 bits (HWE_ST) into a register r2, and a nop instruction. SA11 includes an Id instruction for storing the r1 from data to r0 from memory space addressed by r1. SA12 includes an instruction storing the sum of the register r1 and an immediate 100 into the register r1. SA13 includes an instruction which stores the content of the register r1 into memory space addressed by r2. SA14 and SA15 include add instructions which store the sum of the register r0 and an immediate 1 into the register r0. The program A-1 of Thread A is a model of program writing into a certain hardware accelerator (HWE_A) and obtaining a special operational result when loading the address in 8 nSec of the writing. The operating frequency of the processor on which the program is operating is assumed to be 1 GHz. Thus, eight nop instructions are issued from SA2 to SA9 and three instructions are issued in SA10. Eight instruction issuance cycles with nine nop instructions in total, that is 8 nSec is spared, satisfies load time constraints from the hardware accelerator.

The program B-1 in FIG. 8 describes a group of instructions, included in Thread B1 issued by the instruction issuing unit 112. In the STEP column, execution steps SB1, SB2, . . . SB13 are described in the order of each of the execution steps to be issued. Regarding instructions to be issued in a same cycle of each of the threads, just one load/store instruction can be issued, and an operational and logic instruction, and a transfer instruction are issued three in total. The instructions in SB1 are an add instruction and a Id instruction. The add instruction stores the sum of a register r5 and an immediate 1 into a register r7. The ld instruction loads, to a register r3, a register r2 from memory space addressed by the register r2. The instructions in SB2 include: a comparison instruction which stores 1 into a flag register C6 in the case where the register r5 is greater than the register r7; a st instruction which stores the content of the register r3 into memory space addressed by a register r0; and an add instruction which stores the sum of the register r2 and an immediate 120 into the register r0. The instructions in SB3 include a mov instruction copying the content of the register r5 into a register r6, the st instruction which stores the content of the register r5 into memory space addressed by a register r0, and a br instruction for branching to L028 label when the flag register C6 is set to 1. The instructions in SB4 include a settar instruction and a mov instruction. The settar instruction stores a branch destination address (PC) into a target address register TAR which stores the branch destination. The mov instruction copies an immediate 200 into the register r0. The instruction in SB5 is an add instruction which stores the sum of the register r5 and the register r0 into the register r4. The instruction in SB6 is an s2add instruction which shifts the content of the register r4 in two bits to the left, and stores the sum of the shifted 4 and the register r5 into the register r4. The instruction in SB7 is an add instruction which stores the sum of the register r6 and an immediate 1 into the register r6. The instruction in SB8 is a comparison instruction which stores 1 into the flag register C6 in the case where the register r6 is equal to the register r7 or smaller. The instructions in SB9 include a post increment st instruction, and a jmpf instruction. The post increment st instruction stores the content of the register r5 into memory space addressed by the register r4, and adds 4 to the address r4. The jmpf instruction jumps to the branch destination address (PC) stored in the target address register TAR which stores the branch destination in the case where the flag register C6 is set to 1. The instruction in SB10 is an instruction to copy an immediate 200 into the register r4. The instructions in SB11 through SB13 are add instructions which store the sum of the register r4 and an immediate 1 into the register r4.

The program C-1 shown in FIG. 9 describes a group of instruction, included in Thread C, issued by the instruction issuing unit 112. In the STEP column, execution steps SC1, SC2, . . . SC14 are described in the order of each of the execution steps to be issued. Regarding instructions to be issued in a same cycle of each of the threads, just one load/store instruction can be issued, and an operational and logic instruction, and a transfer instruction can be issued three in total. In SC1, the setlo instruction and the sethi instruction can be issued out of three possible instructions; namely, Instructions 1, 2, and 3. The setlo instruction stores, into the register r0, the lower 16 bits of immediate 32 bits (W_MEM). The sethi instruction stores, into the register r0, the higher 16 bits of the immediate 32 bits (W_MEM). The instructions in SC2 include a post increment ldp instruction and an add instruction. The post increment ldp instruction: loads eight bytes from memory space addressed by the register r0; stores the eight bytes into the registers r2 and r3; and adds 8 to the register r4. The add instruction stores the sum of the register r1 and an immediate 1000 into the register 1. The instructions in SC3 include a post increment ldp instruction, an add instruction, and a sub instruction. The post increment ldp instruction loads eight bytes from the memory space addressed by the register r0, stores the eight bytes into the registers r4 and r5, and adds 8 to the register r0. The add instruction stores the sum of the register r2 and the register r3 into the register r6. The sub instruction stores the difference between the register r2 and the register r3 into the register r7. The instructions in SC4 include a post increment ldp instruction, an add instruction, and a sub instruction. The post increment ldp instruction loads eight bytes from the memory addressed by the register r0, stores the eight bytes into the registers r2 and 3, and adds 8 to the register r0. The add instruction stores the sum of the register r4 and the register r5 into the register r8. The sub instruction stores the difference between the register r4 and the register r5 into the register r9. The instructions in SC5 include the post increment ldp instruction, an add instruction, and a sub instruction. The post increment ldp instruction loads eight bytes from the memory addressed by the register r0, stores the eight bytes into the registers r4 and r5, and adds 4 to the register r0. The add instruction stores the sum of the register r2 and the register r3 into the register r10. The sub instruction stores the difference between the register r2 and the register r3 into the register r11. The instructions in SC6 include a post increment stp instruction, an add instruction, and a sub instruction. The post increment stp instruction stores the content of the registers r6 and r7 for eight bytes into the memory addressed by the register r1, and adds 4 to the register r1. The add instruction stores the sum of the registers r4 and r5 into a register r12. The sub instruction stores the difference between the register r4 and r5 into a register 13. The instruction in SC7 is a post increment stp instruction which stores the content of the registers r8 and r9 for eight bytes into the memory addressed by the register r1, and adds 4 to the register r1. The instruction in SC8 is a post increment stp instruction which stores the content of the registers r10 and r11 for eight bytes into the memory addressed by the register r1, and adds 4 to the register r1. The instruction in SC9 is a post increment stp instruction which stores the content of the registers r12 and r13 for eight bytes into the memory addressed by the register r1, and adds 4 to the register r1. The instructions in SC10 through SC14 store the sum of the register r1 and an immediate 1 into the register r1.

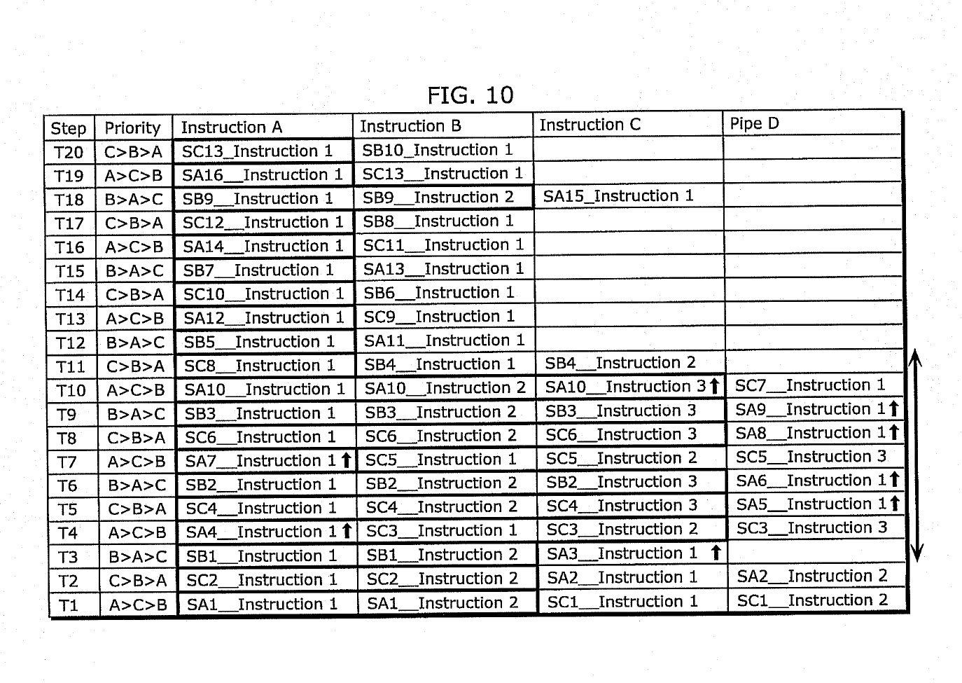

The above has described the content of the program, in each of the threads, for describing operations in the embodiment. Here, using FIG. 10, a description of operations shall be provided, using the processor, shown in FIG. 1, making the SMT execution possible. In order to simplify the description, the instruction issuing unit 112 supports an SMT execution based on the following rules. Each of the threads is assumed to be able to issue up to three instructions. Only two threads can be simultaneously executed based on the priority. Further, in the case where the instructions in each of the threads are simultaneously executed, a group of instructions for each of the threads is preconditioned to be unchanged, and the SMT can be executed only in the case where four instructions can be issued. It is noted that neither the load instruction nor the store instruction can be issued two or more in a same cycle, and the store instruction and the load instruction can be issued simultaneously. Moreover, in order to simplify the description, a branch instruction, various instructions, and load instructions are respectively executed in one cycle.

FIG. 10 is an operational explanatory diagram when the programs A-1 in FIG. 6, B-1 in FIG. 8, and C-1 in FIG. 9 are simultaneously multi-threaded. In the STEP column, execution steps T1, T2 . . . T20 are described in the order of each of the execution steps to be issued. The threads to be executed are arbitrated according to the rules of the Priority column. T1 is instruction-issuance controlled in the priority of A>C>B, and two instructions in SA1 and two instructions SC1 are issued. T2 is instruction-issuance controlled in the priority of C>B>A, and two instructions in SC2 and two instructions in SA2 are issued. The group of instructions in Thread B cannot be issued, and the group of instructions in Thread A can be issued. This is because SB1 includes the load instruction, and thus cannot issue the load instruction simultaneously. T3 is instruction-issuance controlled in the priority of B>A>C, and two instruction in SB1 and one instruction in SA3 are issued. T4 is instruction-issuance controlled in the priority of A>C>B, and one instruction in SA4 and three instructions in SC3 are issued. T5 is instruction-issuance controlled in the priority of is C>B>A, and three instructions in SC4 and one instruction in SA5 are issued. T6 is instruction-issuance controlled in the priority of B>A>C, and three instructions in SB2 and one instruction in SA6 are issued. T7 is instruction-issuance controlled in the priority of A>C>B, and one instruction in SC7 and three instructions in SC5 are issued. T8 is instruction-issuance controlled in the priority of C>B>A, and three instructions in SC6 and one instruction in SA8 are issued. T9 is instruction-issuance controlled in the priority of B>A>C, and three instructions in SB3 and one instruction in SA9 are issued. T10 is instruction-issuance controlled in the priority of A>C>B, and three instructions in SA10 and one instruction in SC7 are issued. T11 is instruction-issuance controlled in the priority of C>B>A, and one instruction in SC8 and two instructions SB4 are issued. T12 is instruction-issuance controlled in the priority of B>A>C, and one instruction in SB5 and one instruction in SA11 are issued. T13 is instruction-issuance controlled in the priority of A>C>B, and one instruction in SA12 and one instruction in SC9 are issued. T14 is instruction-issuance controlled in the priority of C>B>A, and one instruction in SC10 and one instruction in SB6 are issued. T15 is instruction-issuance controlled in the priority of B>A>C, and one instruction in SB7 and one instruction in SA13 are issued. T16 is instruction-issuance controlled in the priority of A>C>B, and one instruction in SC14 and one instruction in SC11 are issued. T17 is instruction-issuance controlled in the priority of C>B>A, and one instruction in SC12 and one instruction in SB8 are issued. T18 is instruction-issuance controlled in the priority of B>A>C, and two instructions in SB9 and one instruction in SA15 are issued. T19 is instruction-issuance controlled in the priority of A>C>B, and one instruction in SA16 and one instruction in SC13 are issued. T20 is instruction-issuance controlled in the priority of C>B>A, and one instruction in SC14 and one instruction in SB10 are issued.

The conventional art utilizing the present invention has been described above. Next, the SMT operations utilizing the embodiment shall be described. Here, the SMT operations are on the program A-2 in FIG. 7.

The program A-2 in FIG. 7 describes a group of instructions, included in Thread A, issued by the instruction issuing unit 112. In the STEP column, execution steps SA′1, SA′2, . . . SA′15 are described in the order of each of the execution steps to be issued. Regarding instructions to be issued in a same cycle of each of the threads, just one load/store instruction can be issued, and an operational and logic instruction, and a transfer instruction can be issued three in total. In SA′1, the setlo instruction and the sethi instruction can be issued out of three possible instructions; namely, Instructions 1, 2, and 3. The setlo instruction stores, into the register r0, the lower 16 bits of immediate 32 bits (HWE_A). The sethi instruction stores, into the register r0, the higher 16 bits of the immediate 32 bits (HWE_A). The subsequent st instruction becomes issueable in SA′2 for hazard evasion for the group of instructions in SA′1. The instruction in SA′2 is a sync_st instruction which can perform instruction synchronous execution detection on an instruction to store the content of the register r1 into memory addressed by the register r0. The sync_st instruction represents an st instruction, with an S bit of bit 31 is set to 1, shown in the instruction bit map described in FIG. 2. SA′3 is a sync_setlo instruction which performs instruction synchronous execution on a setlo instruction which stores the lower 16 bits in the immediate 32 bits (HWE_ST) into the register r2. SA′4 is a sync_setlo instruction which can perform instruction synchronous execution on a sethi instruction which stores the higher 16 bits in the immediate 32 bits (HWE_ST) into the register r2. SA′5 includes an Id instruction which loads data to r1 from memory space addressed by r0. SA′6 includes an add instruction which stores the sum of the register r1 and an immediate 100 into the register r1. SA′7 includes an instruction which stores the content of the register r1 into the memory addressed by r2. The instructions in SA′8 through SA′14 are add instructions which store the sum of the register r0 and the immediate 1 into the register r0. The program A-2 of Thread A (FIG. 7) is a model of a hardware accelerator writing into a certain hardware accelerator (HWE_A) and obtaining a special operational result when loading the address in 8 nSec of the writing. The operating frequency of the processor on which the program is operating is assumed to be 1 GHz. Thus, the processor is featured to have an instruction issuance suspending period for two cycles since the instructions for synchronous execution are detected in order to have 8 nSec spared. Thus, the processor satisfies load time constraints from the hardware accelerator with 8 nSec spared in total by three instruction synchronous executions from SA′2 to SA′4. This shows that, in the synchronization control unit 1060 included in the instruction issuance suspending unit 1000 in FIG. 5, the instruction issuance suspend requesting signal 1010 latched at the flip-flop 1020 is inputted into synchronization control unit 1060, and the instruction issuance suspension state signal 1050 is outputted for two cycles even though the pipeline hazard state signal 1030 is inputted.

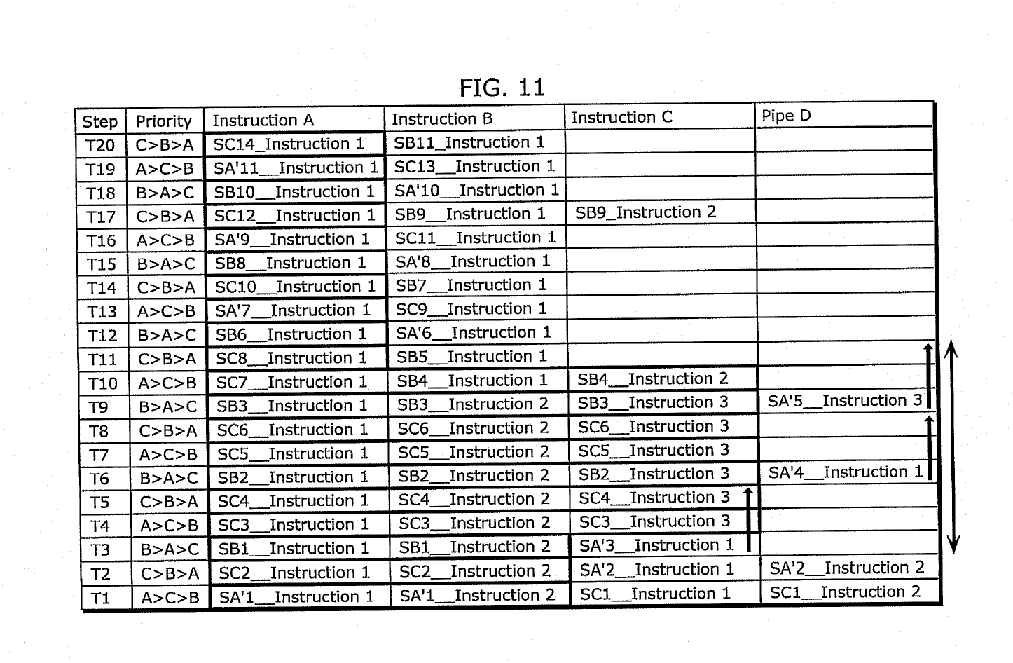

FIG. 11 is an operational explanatory diagram when the programs A-2 in FIG. 7, B-1 in FIG. 8, and C-1 in FIG. 9 are simultaneously multi-threaded. In the STEP column, execution steps T1, T2 . . . T20 are described in the order of each of the execution steps to be issued. The threads to be executed are arbitrated according to the rules of the Priority column. T1 is instruction-issuance controlled in the priority of A>C>B, and two instructions in SA′1 and two instructions in SC1 are issued. T2 is instruction-issuance controlled in the priority of C>B>A, and two instructions in SC2 and two instructions in SA′2 are issued. The group of instructions in Thread B cannot issue instructions, and the group of instructions in Thread A can issue instructions. This is because SB1 includes the load instruction, and thus cannot issue the load instruction simultaneously. T3 is instruction-issuance controlled in the priority of B>A>C, and two instruction in SB1 and one instruction in SA′3 are issued. T4 is instruction-issuance controlled in the priority of A>C>B. Meanwhile, the instruction in SA′4 is not issued since the instruction issuance in SA is prohibited for two cycles due to instruction synchronous execution control. Instead, three instructions in SC3 are issued. T5 is instruction-issuance controlled in the priority of C>B>A; however, only three instructions in SC4 are issued since the instruction in SA′4 is not issued, as shown in T4. T6 is instruction-issuance controlled in the priority of B>A>C, and three instructions in SB2 and one instruction in SA′4 are issued. T7 is instruction-issuance controlled in the priority of A>C>B. Meanwhile, the instruction in SA′5 is not issued due to instruction synchronous execution control. Instead, three instructions in SC5 are issued. T8 is instruction-issuance controlled in the priority of C>B>A; however, only three instructions in SC6 are issued since the instruction in SA′5 is not issued, as shown in T7. T9 is instruction-issuance controlled in the priority of B>A>C, and three instructions in SB3 and one instruction in SA′5 are issued. T10 is instruction-issuance controlled in the priority of A>C>B. Meanwhile, the instruction in SA′6 is not issued due to instruction synchronous execution control. Instead, one instruction in SC7 and two instructions in SB4 are issued. T11 is instruction-issuance controlled in the priority of C>B>A, and one instruction in SC8 and one instruction in SB5 are issued. T12 is instruction-issuance controlled in the priority of B>A>C, and one instruction in SB6 and one instruction in SA′6 are issued. T13 is instruction-issuance controlled in the priority of A>C>B, and one instruction in SA′7 and one instruction in SC9 are issued. T14 is instruction-issuance controlled in the priority of C>B>A, and one instruction in SC10 and one instruction in SB7 are issued. T15 is instruction-issuance controlled in the priority of B>A>C, and one instruction in SB8 and one instruction in SA′8 are issued. T16 is instruction-issuance controlled in the priority of A>C>B, and one instruction in SA′9 and one instruction in SC11 are issued. T17 is instruction-issuance controlled in the priority of C>B>A, and one instruction in SC12 and one instruction in SB9 are issued. T18 is instruction-issuance controlled in the priority of B>A>C, and one instruction in SB10 and one instruction in SA′10 are issued. T19 is instruction-issuance controlled in the priority of A>C>B, and one instruction in SA′11 and one instruction in SC13 are issued. T20 is instruction-issuance controlled in the priority of C>B>A, and one instruction in SC14 and one instruction in SB11 are issued. Specifically, compared with the operations in FIG. 10, the operations in FIG. 11 are devised to satisfy the program operation requirement for Thread A and can improve application performance of other threads (as if the number of instruction issuance for Thread B were increased).

As described above, the use of the instruction synchronous execution detecting unit 121 and the instruction issuance suspending unit 122 in the embodiment ensures the shortest time of the instruction execution time of the thread regardless of an instruction execution state in each of the threads at a computing unit structured in a multi-threaded processor. Further, since the instruction issuance of the thread can be limited with the ensured shortest time, the multithread execution performance to other threads can be improved. In addition, the embodiment includes a unit which can perform a real time execution on all the instructions, since instruction synchronous execution detection is performed in a one-bit instruction bit field.

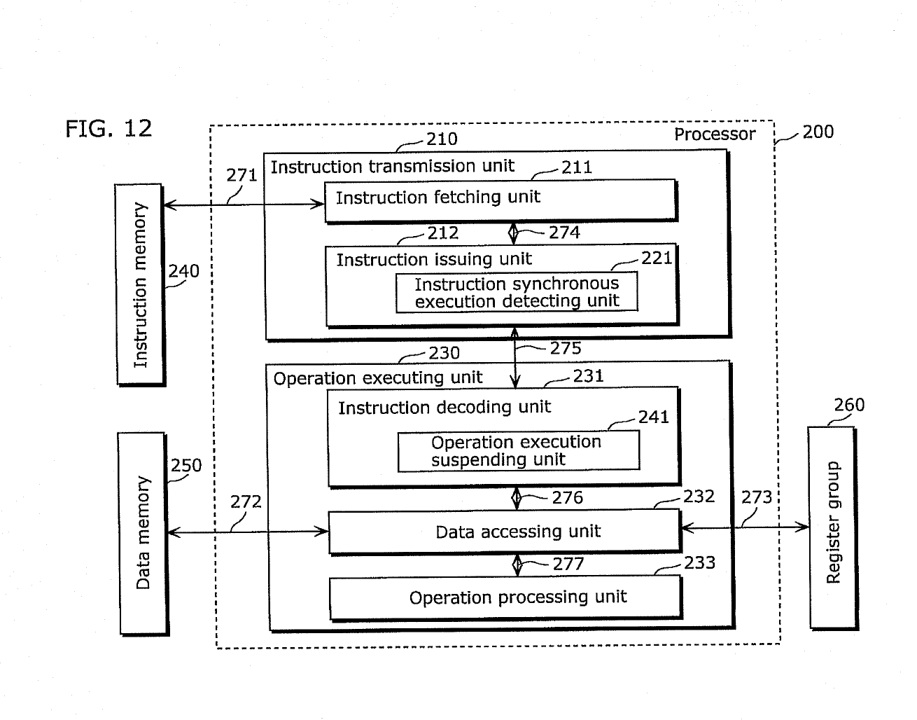

Here, a modification example of the processor in FIG. 1 is shown in FIG. 12. Compared with the processor in FIG. 1, the processor in FIG. 12 is different in that an instruction execution suspending unit 241 is included instead of the instruction issuance suspending unit 122. Other than that point, the processors in FIG. 1 and FIG. 12 share an almost identical structure. Instead of suspending instruction issuance, the processor can be structured to suspend an instruction execution as shown in FIG. 12.

### Second Embodiment

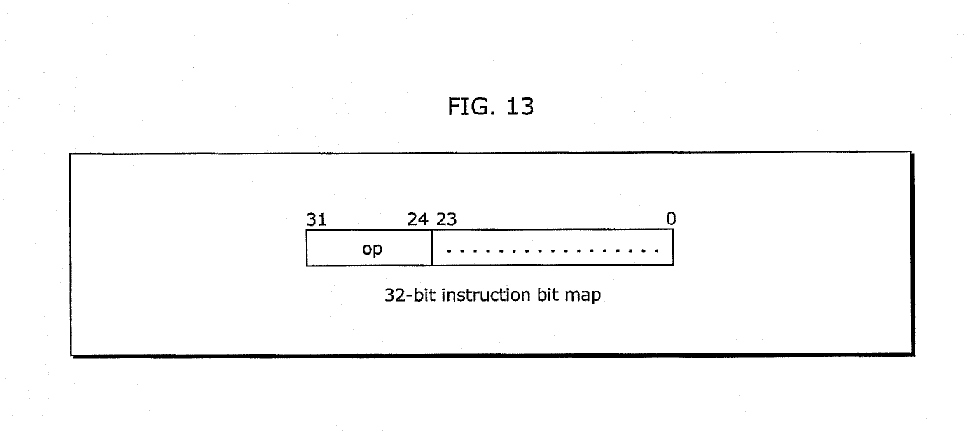

Implementation of the above functions, using one bit in an instruction code in order to perform instruction synchronous execution detection, however, may possibly cause a problem in view of effective use of a limited instruction bit map. Thus, compared with the first embodiment, a second instruction synchronous execution detecting unit shall be described, using FIGS. 13, 14, and 15, as a scheme to avoid wastefully occupying the instruction bit map.

FIG. 13 shows an instruction code of a specific instruction in the second embodiment. The embodiment exemplifies, in principle, a 32-bit fixed instruction bit map. Here, the OP (Operation Code) from the bit 31 to the bit 24 is shown as a specific instruction performing instruction synchronous execution at a certain bit pattern. This specific instruction is not shared with another instruction, as the specific instruction in the first embodiment. Instead, a bit pattern is assigned to be a dedicated instruction. It is noted, however, that an assignment scheme of bit map is not limited to this.

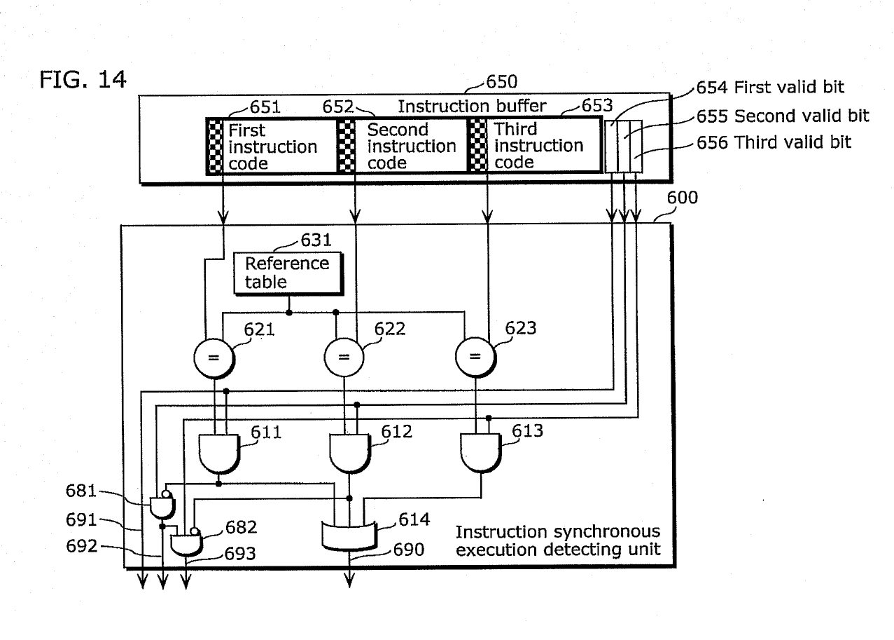

FIG. 14 is a block diagram showing a structure for one thread in an internal structure of an instruction synchronous execution detecting unit. The instruction issuing unit 112 includes an instruction buffer 650 which stores, on a thread-to-thread basis, the instructions up to the largest number of instructions to be issued. In the embodiment, it is assumed that: three instructions can be issued for a thread; two thread instruction groups can be issued simultaneously; and four instructions can be issued simultaneously. The instruction buffer 650 stores: a first instruction code 651, a second instruction code 652, and a third instruction code 653 in the order of program addresses in the program counter. The instruction buffer 650 also stores a first valid bit 654, a second valid bit 655, and the third valid bit 656, showing whether or not an effective instruction is stored in the instruction buffer 650.

The instruction synchronous execution detecting unit 650, which receives the above information as inputs, includes an AND gate 611, an AND gate 611, an AND gate 612, an AND gate 613, an OR gate 614, comparators 621 to 623, and a reference table 631. The AND gate 611 receives, as inputs, the following: an output from a comparator 621 connected to a reference table 631; and the first valid bit 654. The AND gate 612 receives, as inputs, the following: an output between the bit 31 and the bit 24 in the second instruction code 652; an output from a comparator 622 connected to the reference table 631; and the second valid bit 655. The AND gate 613 receives, as inputs, the following: an output from the comparator 623 connected to the reference table 631; and the third valid bit 656. The OR gate 614 receives inputs from the AND gates 611, 612, and 613. As an output from the OR gate 614, an instruction synchronous execution detecting signal 690 is generated. The instruction synchronous execution detecting signal 690 indicates the fact an instruction for which synchronous execution is required is generated

The reference table 631 stores an instruction code (bit pattern) of the specific instruction. Each of the comparators 621 to 623 detects the specific instruction by pre-decoding instruction bit fields of bits in as an instruction code.

Further, a first instruction code valid bit 691, a second instruction code valid bit 692, and a third instruction code valid bit 693 are generated. The first instruction code valid bit 691 directly outputs the first valid bit 654 in order to indicate whether or not an instruction stored in the instruction buffer can be eventually issued according to the instruction synchronous execution detecting signal. The second instruction code valid bit 692 receives the second valid bit 655 and an inverted output from the AND gate 611 as inputs, and outputs the inputs as an output from the AND gate 681. The third instruction code valid bit 693: receives the third valid bit 656, the output from the AND gate 681, and an inverted output from the AND gate 612 as inputs, and outputs the inputs as an output from the AND gate 682. As described the above, the instruction synchronous execution detecting signal 690 outputted from the instruction synchronous execution detecting unit 600 indicates that an instruction performing synchronization is included in the group of instructions, and the first instruction code valid bit 691, the second instruction code valid bit 692, and the third instruction code valid bit 693 can identify a code, in a thread, which can issue an instruction. It is noted that the instruction synchronous execution detecting unit 600 in FIG. 14 shows control signals in only one thread. Since a processor simultaneously executable three thread is assumed in the embodiment, the resources for the threads are required for each thread. The structure of the processor is obvious from a viewpoint of a processor having an SMT-executable structure; therefore, the description of the structure shall be omitted hereinafter.

As described above, in order to avoid wastefully occupying an instruction bit map, the second instruction synchronous execution detecting unit allows the SMT-executable processor in the first embodiment to provide, without occupying the bit map, an operational processing apparatus which can adjust the shortest time of an execution time of a program corresponding to the thread with the smallest granularity regardless of execution states of the other threads.

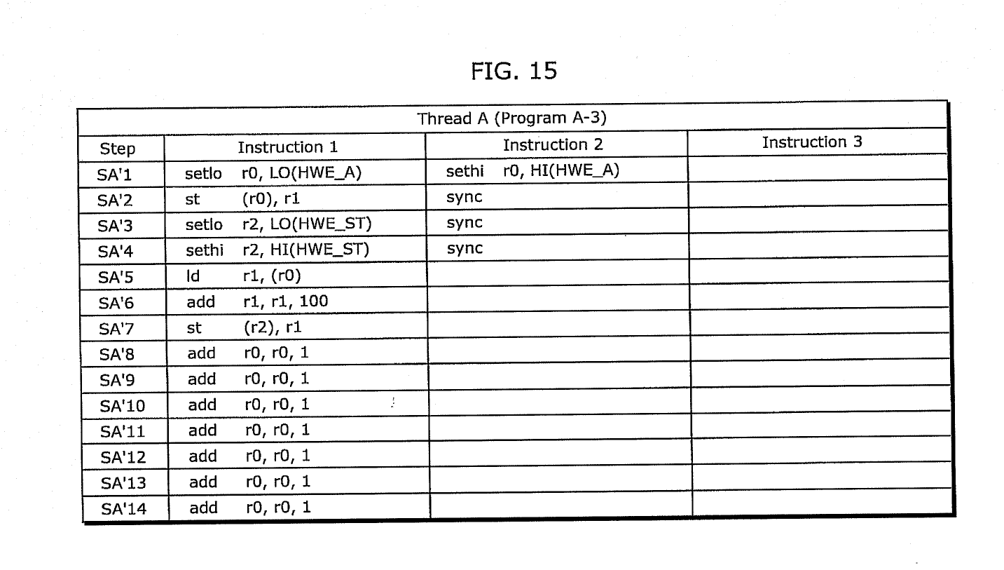

As a program described in the embodiment, a program A-3 in FIG. 15, with only sync instructions added to the instruction bit map, shall be described, hereinafter.

The program A-3 shown in FIG. 15 describes groups of instruction, included in Thread A, issued by the instruction issuing unit 112. In the STEP column, steps SA′1, SA′2, . . . , SA′15 are described in the order of each of the execution steps to be issued. Regarding instructions to be issued in a same cycle of each of the threads, just one load/store instruction can be issued, and an operational and logic instruction, and a transfer instruction are issued three in total. In SA′1, the setlo instruction and the sethi instruction can be issued out of three possible instructions; namely, Instructions 1, 2, and 3. The setlo instruction stores, into a register r0, the lower 16 bits of immediate 32 bits (HWE_A). The sethi instruction stores, into the register r0, the higher 16 bits of immediate 32 bits (HWE_A). The subsequent st instruction is issueable in SA′2 for hazard evasion for the group of instructions in SA1. The instructions in SA′2 include an instruction which stores the content of a register r1 into memory addressed by the r0, and a sync instruction which can perform instruction synchronous execution. SA′3 includes the sync instruction and the setlo instruction which stores the lower 16 bits of immediate 32 bits (HWE_ST) into the register r2. SA′4 includes the sync instruction and the sethi instruction which stores the higher 16 bits of the immediate 32 bits (HWE_ST) into the register r2. SA′5 is an Id instruction which loads data to the register r1 from memory space addressed by the register r0. SA′6 includes an instruction which stores the sum of the register r1 and an immediate 100 into the register r1. SA′7 includes an instruction which stores the content of the register r1 into memory addressed by a register r2. SA′8 through SA′14 include add instructions which store the sum of the register r0 and an immediate 1 into the register r0. The program A-3 of Thread A (FIG. 15) is a model of a program writing into a certain hardware accelerator (HWE_A) and obtaining a special operational result when loading the address in 8 nSec of the writing. The operating frequency of the processor on which the program is operating is assumed to be 1 GHz. The processor is featured to have an instruction issuance suspending period for two cycles since an instruction for the instruction synchronous execution is detected in order to have 8 nSec spared. Thus, the processor satisfies load time constraints from the hardware accelerator with 8 nSec spared in total by three instruction synchronous executions from SA′2 to SA′4. This shows that, in FIG. 5, the instruction issuance suspending requesting signal 1010 latched at the flip-flop 1020 is inputted into the synchronization control unit 1060, a state machine, at the synchronization control unit 1060 in the instruction issuance suspending unit 1000, and the instruction issuance suspension state signal 1050 is outputted for two cycles even though the pipeline hazard state signal 1030 is inputted.

As described above, the use of the second instruction synchronous execution detecting unit 600 and the instruction issuance suspending unit 122 in the embodiment ensures the shortest time of the instruction execution time of the thread regardless of an instruction execution state in each of the threads at a computing unit structured in a multi-threaded processor. Further, since the instruction issuance of the thread can be limited with the ensured shortest time, the multithread execution performance to other threads can be improved. In addition, the embodiment includes a unit which can perform a real time execution only on a specific instruction, since instruction synchronous execution detection is performed by decoding instruction bit fields of bits.

### Third Embodiment

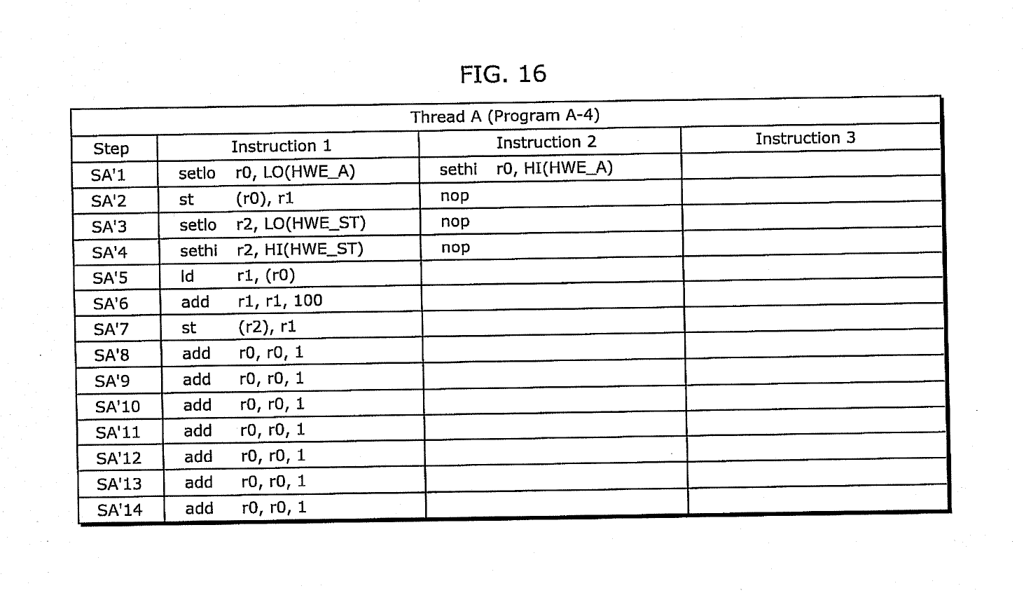

Suppose a dedicated sync instruction is added in order to perform instruction synchronous execution detection. Here, the sync instruction is dedicated for performing instruction synchronous execution detection by decoding an instruction bit field. This, however, requires to change software development environment, as well as to change instruction specifications, and thus, causes a significant problem. Thus, a second instruction synchronous execution detecting unit shall be described, using a program A-4 in FIG. 16. The second instruction synchronous execution detecting unit can be realized by a scheme for expanding a nop instruction having an equivalent function as a newly generated instruction without generating the new instruction, compared with the second embodiment.

In the STEP column, steps SA′1, SA′2, . . . , SA′15 are described in the order of each of the execution steps to be issued. Regarding instructions to be issued in a same cycle of each of the threads, just one load/store instruction can be issued, and an operational and logic instruction, and a transfer instruction are issued three in total. In SA′1, the setlo instruction and the sethi instruction can be issued out of three possible instructions; namely, Instructions 1, 2, and 3. The setlo instruction stores, into a register r0, the lower 16 bits of immediate 32 bits (HWE_A). The sethi instruction stores, into the register r0, the higher 16 bits of the immediate 32 bits (HWE_A). The subsequent st instruction is issueable in SA′2 for hazard evasion for the group of instructions in SA′1. The instructions in SA′2 include an instruction which stores the content of a register r1 into memory addressed by the register r0, and a nop instruction which can perform instruction synchronization detection. SA′3 includes the setlo instruction which stores the lower 16 bits of the immediate 32 bits (HWE_ST) into a register r2, and the nop instruction which can perform instruction synchronization detection. SA′4 includes the sethi instruction which stores the higher 16 bits of the immediate 32 bits (HWE_ST) into the register r2, and the nop instruction which can perform instruction synchronization detection. SA′5 includes an Id instruction which loads data to the register r1 from memory space addressed by the register r0. SA′6 includes an instruction which stores the sum of the register r1 and an immediate 100 into the register r1. The instruction in SA′7 includes an instruction which stores the content of the register r1 into memory addressed by the register r2. SA′8 through SA′14 include add instructions which store the sum of the register r0 and an immediate 1 into the register r0. The program A-4 of Thread A (FIG. 16) is a model of a hardware accelerator writing into a certain hardware accelerator (HWE_A) and obtaining a special operational result when loading the address in 8 n seconds of the writing. The operating frequency of the processor on which the program is operating is assumed to be 1 GHz. The processor is featured to have an instruction issuance suspending period for two cycles since instruction for the instruction synchronous execution is detected in order to have 8 nSec spared. Thus, the processor satisfies load time constraints from the hardware accelerator with 8 nSec spared in total by three instruction synchronous executions in SA′2 through SA′4. This shows that, in FIG. 5, the instruction issuance suspending requesting signal 1010 latched at the flip-flop 1020 is inputted into the synchronization control unit 1060, a state machine, at the synchronization control unit 1060 in the instruction issuance suspending unit 1000, and the instruction issuance suspension state signal 1050 is outputted for two cycles even though the pipeline hazard state signal 1030 is inputted. This allows a similar effect to the program A-3 (FIG. 15) to be obtained, without changing instruction specifications.

### Fourth Embodiment

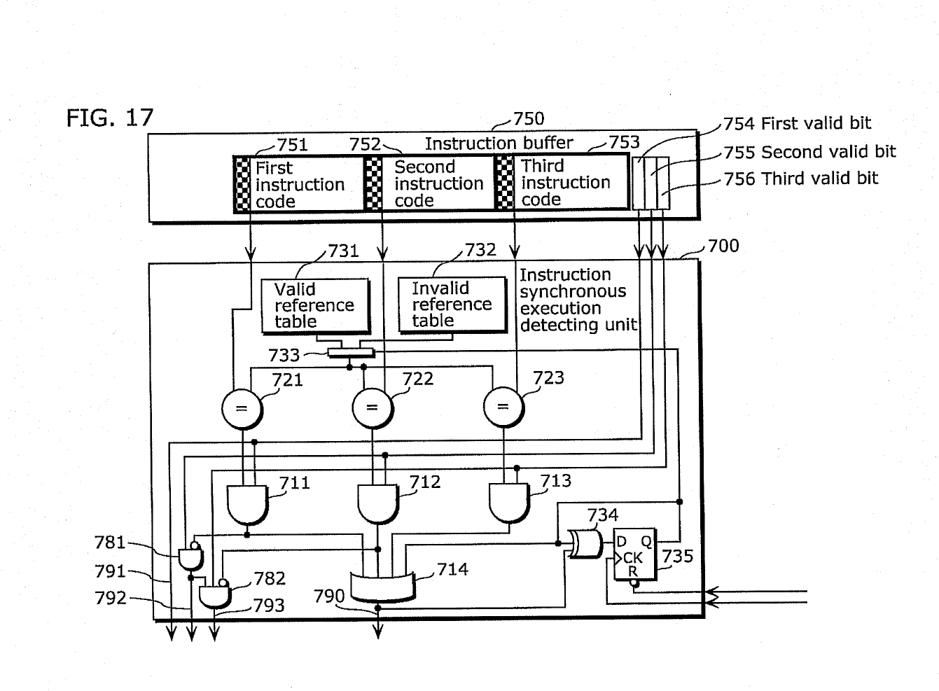

Substituting the nop instructions for the sync instructions still requires two instructions for Thread A in each of the steps. Thus, a group of instructions, which can issue three instructions in another thread, may not possibly issue an instruction. Hence, solving the problem can further improve the performance. Since instruction synchronous execution detection may be performed only in the period in which the load/store instruction is performed, by using a wt instruction and an rd instruction which are register access instructions dedicated to a hardware accelerator, a third instruction synchronization detection invalidating unit and a third instruction synchronization mode state storing unit in FIGS. 17 and 4 can improve the performance. Here, the load/store instruction is sent to a hardware device such as the hardware accelerator.

FIG. 17 is a block diagram showing a structure for one thread in an internal structure of an instruction synchronous execution detecting unit in a fourth embodiment. The instruction issuing unit 112 includes an instruction buffer 750 which stores, on a thread-to-thread basis, the instructions up to the largest number of instructions to be issued. In the embodiment, it is assumed that: three instructions can be issued for a thread; two thread instruction groups can be issued simultaneously; and four instructions can be issued simultaneously. The instruction buffer 750 stores: a first instruction code 751, a second instruction code 752, and a third instruction code 753 in the order of program addresses in the program counter. The instruction buffer 750 also stores a first valid bit 754, a second valid bit 755, and the third valid bit 756, showing whether or not an effective instruction is stored in buffers including the instruction buffer 750. The instruction synchronous execution detecting unit 700, which receives the above information as inputs, includes an AND gate 711, an AND gate 712, an AND gate 713, and an OR gate 714. The AND gate 711, as inputs, receives an output between the bit 31 and bit 24 in the first instruction code 751, an output from a comparator 721 connected to a reference table selector 733, and the first valid bit 754. The AND gate 712 receives, as inputs, an output between the bit 31 and the bit 24 in the second instruction code 752, an output from a comparator 722 connected to the reference table selector 733, and the second valid bit 755. The AND gate 713 receives, as inputs, an output between the bit 31 and the bit 24 in the third instruction code 753, an output from the comparator 723 connected to the reference table selector 733, and the third valid bit 756. The OR gate 714 receives, as inputs, outputs from the AND gates 711, 712, 713, and a flip-flop with reset 735. As an output from the OR gate 714, an instruction synchronous execution detecting signal 790 is generated. The instruction synchronous execution detecting signal 790 indicates the fact an instruction for which synchronous execution is required is generated. Further, the output of the OR gate 7114 is inputted into an EXOR gate 734 along with an output of the flip-flop 735. An output of the EXOR gate 734 is connected to a data input of the flip-flop 735. This enables the instruction synchronous execution detection valid sate detected by the instruction synchronous execution detecting unit to be remained. Moreover, an instruction synchronous execution detection invalid request detected by the instruction synchronization executing unit can clear the valid state. Further, the output from the flip-flop can be used as a select signal of the selector 733 for a valid reference table 731 and an invalid reference table 732. Further, a first instruction code valid bit 791, a second instruction code valid bit 792, and a third instruction code valid bit 793 are generated. The first instruction code valid bit 791 directly outputs the first valid bit 754 in order to indicate whether or not an instruction stored in the instruction buffer can be eventually issued according to the instruction synchronous execution detecting signal. The second instruction code valid bit 792 receives the second valid bit 755 and an inverted output from the AND gate 711 as inputs, and outputs the inputs as an output from the AND gate 781. The third instruction code valid bit 793: receives the third valid bit 756, the output from the AND gate 781, and an inverted output from the AND gate 712 as inputs; and outputs the inputs as an output from the AND gate 782. As described the above, the instruction synchronous execution detecting signal 790 outputted from the instruction synchronous execution detecting unit 700 indicates that an instruction performing synchronization is included in the group of instructions, and the first instruction code valid bit 791, the second instruction code valid bit 792, and the third instruction code valid bit 793 can identify a code, in a thread, which can issue an instruction. It is noted that the instruction synchronous execution detecting unit 700 in FIG. 17 shows control signals in only one thread. Since a processor simultaneously executable three thread is assumed in the embodiment, the resources for the threads are required for each of the threads. The structure of the processor is obvious from a viewpoint of a processor having an SMT-executable structure; therefore, the description of the structure shall be omitted hereinafter.

FIG. 4 describes an instruction synchronous execution mode storing unit stored in a processor state register. A register group 900 includes the processor state register 910, general registers 912 to 915, and operand data latches 921 to 924. The processor state register 910 stores a SYNC bit 950. The SYNC bit 950 is set and reset by the instruction synchronous execution detecting signal 790 described in FIG. 17. In addition, the SYNC bit 950 is reset when interruption processing occurs.

This allows the synchronous execution mode to be stored as a processor state. Thus, the state can be managed even in the case where the thread is brunched due to the interruption.

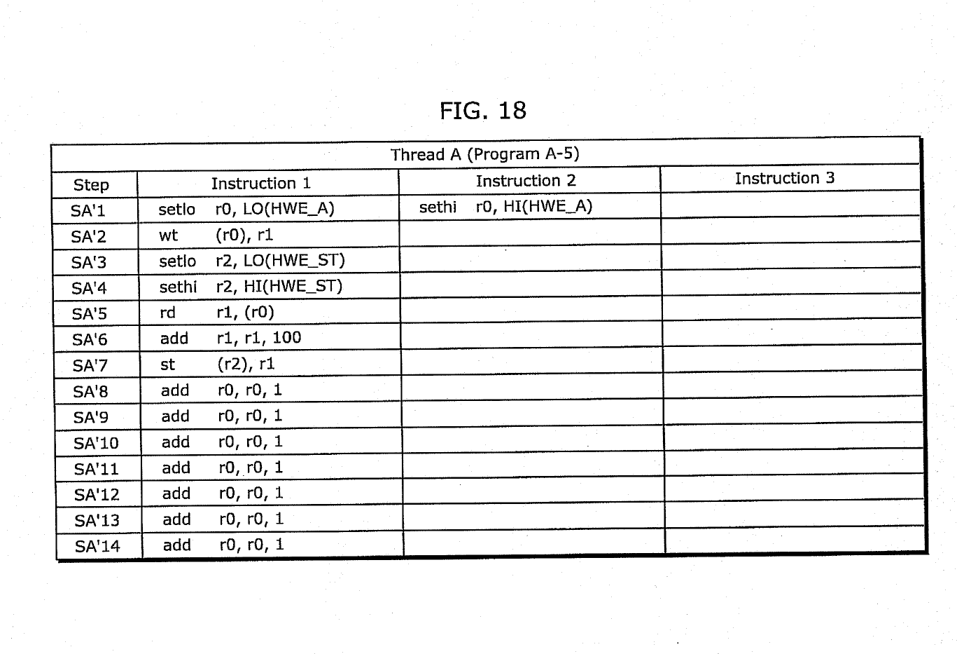

As an operation description in the embodiment, a program A-5 in FIG. 18, using a register access instruction, shall be described hereinafter.

The program A-5 shown in FIG. 18 describes groups of instruction, included in Thread A, issued by the instruction issuing unit 112. In the STEP column, steps SA l, SA′2, . . . , SA′15 are described in the order of each of the execution steps to be issued. Regarding instructions to be issued in a same cycle of each of the threads, just one load/store instruction can be issued, and an operational and logic instruction, and a transfer instruction are issued three in total. In SA′1, the setlo instruction and the sethi instruction can be issued out of three possible instructions; namely, Instructions 1, 2, and 3. The setlo instruction stores, into a register r0, the lower 16 bits of immediate 32 bits (HWE_A). The sethi instruction stores, into the register r0, the higher 16 bits of the immediate 32 bits (HWE_A). The subsequent wt instruction is issueable in SA′2 for hazard evasion for the group of instructions in SA′1. The instruction in SA′2 includes the wt instruction which stores the content of a register r1 into a register of a hardware accelerator addressed by the register r0. When the wt instruction for an instruction synchronization execution is executed, Thread A is set to the instruction synchronization mode. SA′3 includes the setlo instruction which stores the lower 16 bits of the immediate 32 bits (HWE_ST) into the register r2. The setlo instruction is executed alone since the setlo instruction is executed in the instruction synchronization mode. SA′4 includes the sethi instruction which stores the higher 16 bits of the immediate 32 bits (HWE_ST) into the register r2. The sethi instruction is executed alone since the sethi instruction is executed in the instruction synchronization mode. SA′5 is a rd instruction which loads data to the register r0 from a register of a hardware accelerator addressed by the register r0. This instruction cancels the instruction synchronization mode. SA′6 includes an instruction which stores the sum of the register r1 and an immediate 100 into the register r1. The instruction in SA′7 includes an instruction which stores the content of the register r1 into memory addressed by the register r2. SA′8 through SA′14 include add instructions which store the sum of the register r0 and an immediate 1 into the register r0. The program A-5 of Thread A (FIG. 18) is a model of a hardware accelerator writing into Zs a certain hardware accelerator (HWE_A) and obtaining a special operational result when loading the address in 8 n seconds of the writing. The operating frequency of the processor on which the program is operating is assumed to be 1 GHz. The processor is featured to have an instruction issuance suspending period for two cycles since the instruction for the instruction synchronous execution is detected in order to have 8 nSec spared. Thus, the processor satisfies load time constraints from the hardware accelerator with 8 nSec spared in total by three instruction synchronous executions in SA′2 through SA′4. This shows that, in FIG. 5, the instruction issuance suspending requesting signal 1010 latched at the flip-flop 1020 is inputted into the synchronization control unit 1060, a state machine, at the synchronization control unit 1060 in the instruction issuance suspending unit 1000, and the instruction issuance suspension state signal 1050 is outputted for two cycles even though the pipeline hazard state signal 1030 is inputted. Thus, the above shows that the instruction synchronous execution detecting signal 790 showing the instruction synchronous execution mode is generated, and the number of instruction issuance of the thread can be set to 1, by the operations described in the first through the third embodiments, using a write instruction for an instruction synchronous execution validation instruction and a read instruction for an instruction synchronous execution invalidation instruction. Thus, instruction issuance of another thread does not restrict issuance of instruction.

### Fifth Embodiment

In the case where an instruction synchronous execution detecting unit, having a unit for storing an instruction synchronization mode, receives an interruption, a time needed for the interruption processing takes longer than storing an instruction. Thus, a mechanism can reduce an unnecessary period for an instruction synchronous execution mode. This allows a wait period to a hardware accelerator for the thread to be hidden by an interruption processing time, as well as allows another thread to improve the performance.

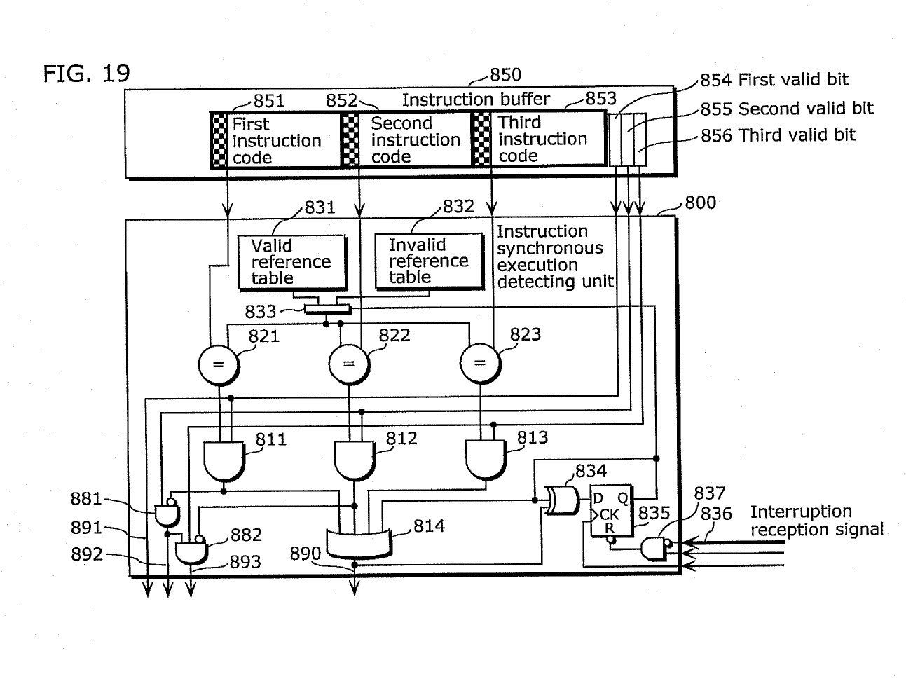

A fifth embodiment shall be described, using FIG. 19 corresponding to the improved circuit of FIG. 17 shown in the third embodiment. FIG. 19 is a block diagram showing a structure for one thread in an internal structure of an instruction synchronous execution detecting unit in the fifth embodiment. The instruction issuing unit 112 includes an instruction buffer 850 which stores, on a thread-to-thread basis, instructions up to the largest number of instructions to be issued. In the embodiment, it is assumed that: three instructions can be issued for a thread; two thread instruction groups can be issued simultaneously; and four instructions can be issued simultaneously. The instruction buffer 850 stores: a first instruction code 851, a second instruction code 852, and a third instruction code 853 in the order of program addresses in the program counter. The instruction buffer 850 also stores a first valid bit 854, a second valid bit 855, and the third valid bit 856, showing whether or not an effective instruction is stored in buffers including the instruction buffer 850. The instruction synchronous execution detecting unit 800, which receives the above information as inputs, includes an AND gate 811, an AND gate 812, an AND gate 813, and an OR gate 814. The AND gate 811 receives, as inputs, an output between the bit 31 and the bit 24 in the first instruction code 851, an output from a comparator 821 connected to a reference table selector 833, and the first valid bit 854. The AND gate 812 receives, as inputs, an output between the bit 31 and the bit 24 in the second instruction code 852, an output from a comparator 822 connected to the reference table selector 833, and the second valid bit 855. The AND gate 813 receives, as inputs, an output between the bit 31 and the bit 24 in the third instruction code 853, an output from the comparator 823 connected to the reference table selector 833, and the third valid bit 856. The OR gate 814 receives, as inputs, outputs from the AND gates 811, 812, 813, and a flip-flop with reset 835. As an output from the OR gate 814, an instruction synchronous execution detecting signal 890 is generated. The instruction synchronous execution detecting signal 890 indicates the fact an instruction for which synchronous execution is required is generated. Further, this output is inputted into the output of the flip-flop with reset 835 and an EXOR gate 834, and connected to a data input of the flip-flop with reset 835. Moreover, a reset terminal of the flip-flop 835 is connected to an AND gate 837 receiving an inversion signal and a reset signal of an interruption reception signal as inputs. This enables the instruction synchronous execution detection valid sate detected by the instruction synchronous execution detecting unit to be remained. Moreover, an instruction synchronous execution detection invalid request detected by the instruction synchronization executing unit, or a reception of the interruption can clear the valid state. Further, the output from the flip-flop can be used as a select signal of a reference table selector 833 for a valid reference table 831 and an invalid reference table 832. Further, a first instruction code valid bit 891, a second instruction code valid bit 892, and a third instruction code valid bit 893 are generated. The first instruction code valid bit 891 directly outputs the first valid bit 854 in order to indicate whether or not an instruction stored in the instruction buffer can be eventually issued according to the instruction synchronous execution detecting signal. The second instruction code valid bit 892 receives the second valid bit 855 and an inverted output from the AND gate 811 as inputs, and outputs the inputs as an output from the AND gate 881. The third instruction code valid bit 893: receives the third valid bit 856, the output from the AND gate 881, and an inverted output from the AND gate 812 as an input; and outputs the inputs as an output from the AND gate 882. As described the above, the instruction synchronous execution detecting signal 890 outputted from the instruction synchronous execution detecting unit 800 indicates that an instruction performing synchronization is included in the group of instructions, and the first instruction code valid bit 891, the second instruction code valid bit 892, and the third instruction code valid bit 893 can identify a code, in a thread, which can issue an instruction. It is noted that the instruction synchronous execution detecting unit 800 in FIG. 19 shows control signals in only one thread. Since a processor simultaneously executable three threads is assumed in the embodiment, the resources for the threads are required for each of the threads. The structure of the processor is obvious from a viewpoint of a processor having an SMT-executable structure; therefore, the description of the structure shall be omitted hereinafter.

### Sixth Embodiment

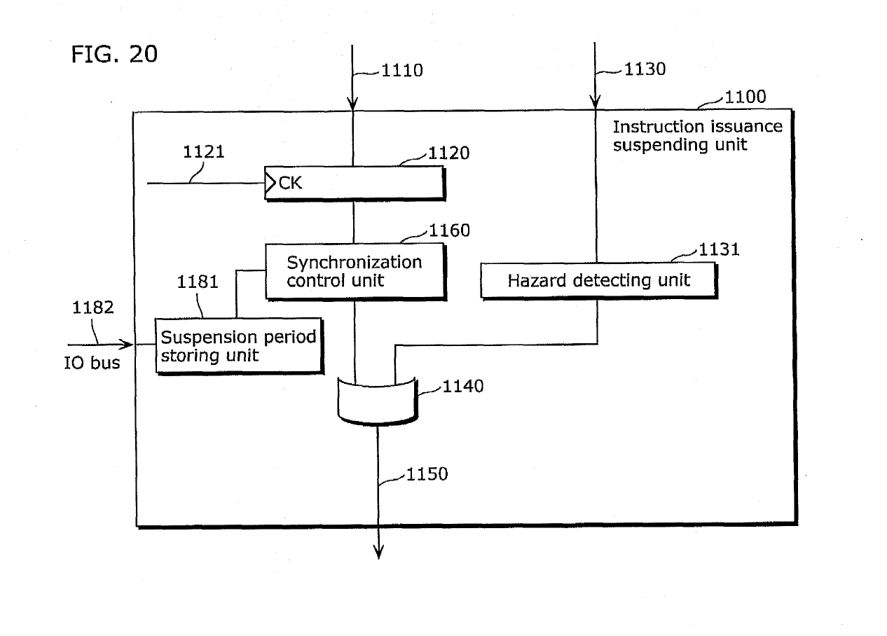

Meanwhile, the number of cycles which suspend issuing the instruction is fixed in the instruction issuance suspending units described in the embodiments 1 through 5, however. Actually, a processor can be structured in a form of a Large-Scale Integration (LSI) circuit with various operating frequencies, and thus the processor needs to be in a programmable structure as a period guarantee of an actual time. A sixth embodiment shall be described, using FIG. 20 corresponding to the improved circuit of FIG. 5 shown in the first embodiment.

FIG. 20 is a block diagram showing a structure of an instruction issuance suspending unit for one thread in a sixth embodiment. An instruction issuance suspending unit 1100 receives an instruction issuance suspending requesting signal 1110 and a pipeline hazard state signal 1130 as inputs. The instruction issuance suspending requesting signal 1110 is obtained from the instruction synchronous execution detecting signal 590 outputted from the instruction synchronous execution detecting unit 121. The pipeline hazard state signal 1130, which relates to pipeline hazard, is obtained from the instruction issuing unit 212 and the operation executing unit 230. The instruction issuance suspending unit 1100 includes a flip-flop 1120, a synchronization control unit 1160, and a hazard detecting unit 1131. The flip-flop 1120 receives, as inputs, an instruction issuance suspending requesting signal 1110, and a clock signal 1121 used in the instruction transmission unit. The synchronization control unit 1160 is a state machine, generating a signal which shows an instruction issuance suspending period, receiving an output from the flip-flop 1020 as an input. The hazard detecting unit 1131 is a stage machine, generating a signal which shows the instruction issuance suspending period, which receives a pipeline hazard state signal 1130 as an input. The synchronization control unit 1160 is connected to a suspension period storing unit 1181 connected to an IO bus 1182, and a state machine of the synchronization control unit 1160 asserts as many instruction issuance prohibition state signals as the number of cycles stored in the suspension period storing unit 1181. The instruction issuance suspending unit 1100 includes the synchronization control unit 1160, the hazard detecting unit 1131, and an OR gate 1140. Here, the OR gate 1140 receives inputs from the synchronization control unit 1160 and the hazard detecting unit 1131. As described above, the instruction issuance suspension state signal 1150 outputted from the OR gate 1140 is generated as an output signal from the instruction issuance suspending unit 1100, and thus, a signal is generated out of the instruction issuance suspension state signal 1150, the signal indicating the issuance of an instruction of the thread in the next cycle to be impossible. It is noted that instruction issuance suspending unit 1100 in FIG. 20 shows control signals in only one thread. Since a processor simultaneously executable three thread is assumed in the embodiment, the resources for the threads are required for each thread. The structure of the processor is obvious from a viewpoint of a processor having an SMT-executable structure; therefore, the description of the structure shall be omitted hereinafter.

### Seventh Embodiment

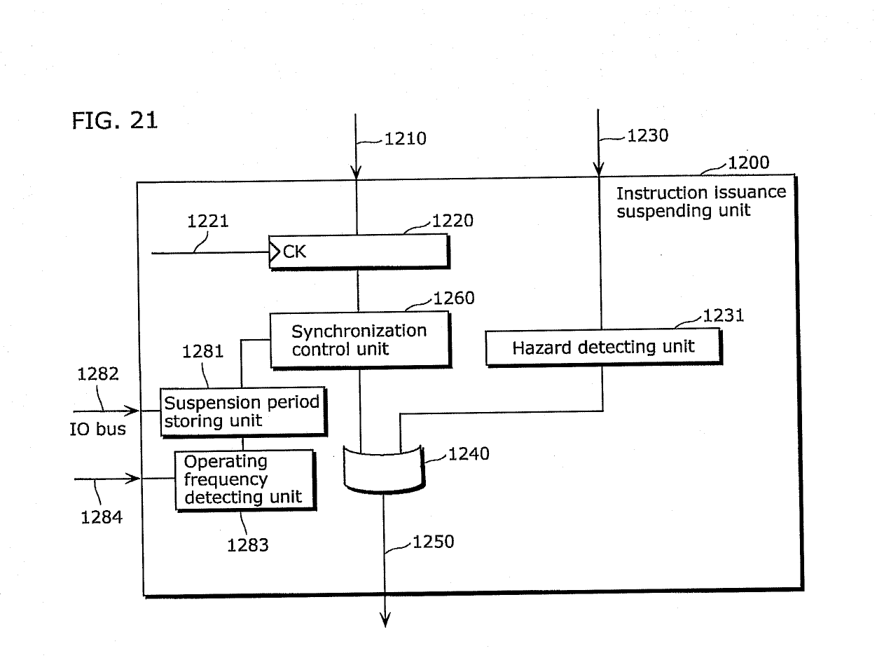

Meanwhile, in actual time guarantee for guarantee for real-time communication, there are cases where an operational frequency of a processor and an operating frequency ratio can be dynamically changed. In this case, as well, the present invention needs to guarantee a period of an actual time (what nSec). Hence, an operational processing apparatus featuring to include an operating frequency detecting unit shall be described, using FIG. 21. Here, the operating frequency detecting unit obtains an operating frequency to the second instruction issuance suspending unit, or an operating frequency ratio of a processor and a hardware accelerator.

FIG. 21 is a block diagram showing a structure of an instruction issuance suspending unit for one thread in a seventh embodiment. An instruction issuance suspending unit 1200 receives an instruction issuance suspending requesting signal 1210 and a pipeline hazard state signal 1230 as inputs. The instruction issuance suspending requesting signal 1210 is obtained from the instruction synchronous execution detecting signal 590 outputted from the instruction synchronous execution detecting unit 121. The pipeline hazard state signal 1230, which relates to pipeline hazard, is obtained from the instruction issuing unit 212 and the operation executing unit 230. The instruction issuance suspending unit 1200 includes a flip-flop 1220, a synchronization control unit 1260, and a hazard detecting unit 1231. The flip-flop 1220 receives, as inputs, an instruction issuance suspending requesting signal 1210, and a clock signal 1221 used in the instruction transmission unit. The synchronization control unit 1260 is a state machine, generating a signal which shows an instruction issuance suspending period, receiving an output from the flip-flop 1020 as an input. The hazard detecting unit 1231 is a stage machine, generating a signal which shows the instruction issuance suspending period, which receives a pipeline hazard state signal 1230 as an input. The synchronization control unit 1260 is connected to a suspension period storing unit 1281 connected to an IO bus 1282, and a state machine of the synchronization control unit 1260 asserts as many instruction issuance prohibition state signals as the number of cycles stored in the suspension period storing unit 1281. In addition, the instruction issuance suspending unit 1200 includes an operating frequency detecting unit 1283 which can obtain an operating frequency of a currently running processor, or an operating frequency ratio of the processor and a hardware accelerator. A suspending period storing unit 1281: looks up a set value thereof, based on the information stored in the operating frequency detecting unit 1283; and then outputs the set value to the synchronization control unit 1260. The instruction issuance suspending unit 1200 includes the synchronization control unit 1260, the hazard detecting unit 1231, and an OR gate 1240. Here, the OR gate 1240 receives inputs from the synchronization control unit 1260 and the hazard detecting unit 1231. This generates an instruction issuance suspension state signal 1250 as an output signal from the instruction issuance suspending unit 1200, and thus, a signal is generated out of the instruction issuance suspension state signal 1250, the signal indicating the issuance of an instruction of the thread in the next cycle to be impossible. It is noted that instruction issuance suspending unit 1200 in FIG. 21 shows control signals in only one thread. Since a processor simultaneously executable three threads is assumed in the embodiment, the resources for the threads are required for each of the threads. The structure of the processor is obvious from a viewpoint of a processor having an SMT-executable structure; therefore, the description of the structure shall be omitted hereinafter.

### Eighth Embodiment

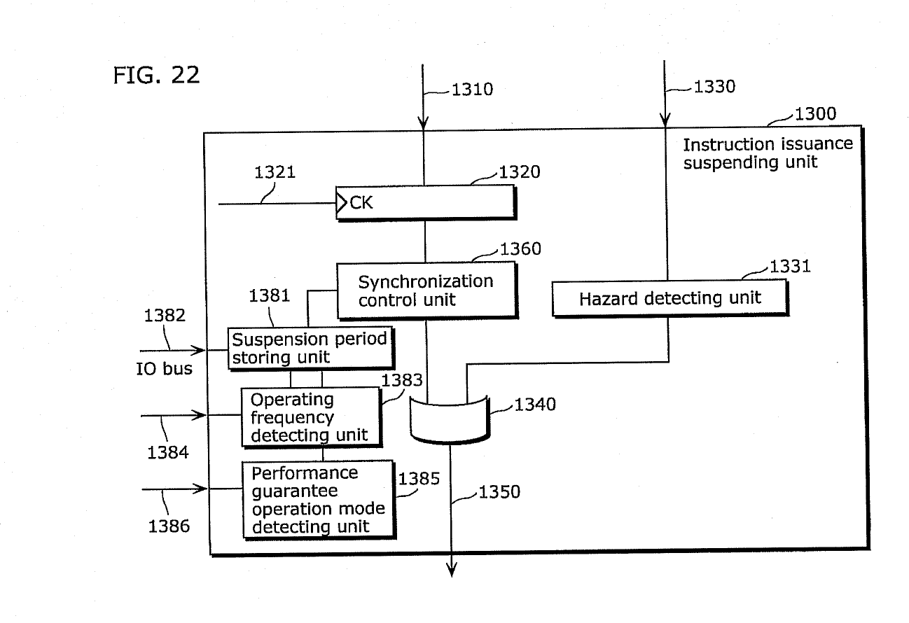

Here, plural operation modes are assumed in the SMT execution scheme. For example, even on a processor which is executable three threads, there are cases of providing: a three-thread equivalent mode arbitrating three threads by round robin; and two threads as priority threads, and the rest of one thread executing with a yield. In that case, a timing for instruction arbitration depends on whether the thread is either a priority thread or a yield thread. Hence, the embodiment describes, using FIG. 22, an operational processing apparatus including a performance guarantee operation mode detecting unit detecting whether or not a thread in the thread is assigned as a priority thread or a yield thread and switching an instruction synchronous execution period.

FIG. 22 is a block diagram showing a structure of an instruction issuance suspending unit for one thread in an eighth embodiment. Compared with the instruction issuance suspending unit in FIG. 21, the instruction issuance suspending unit in FIG. 22 additionally includes the performance guarantee operation mode detecting unit.

A performance guarantee operation mode detecting unit 1385 detects whether or not an operation mode is more prioritized than another thread. For example, the performance guarantee operation mode detecting unit 1385 detects whether the thread is a priority thread or a yield thread.

A suspension period storing unit 1382 stores the number of cycles showing a suspension period on an operation mode-to-operation mode basis. In the case of a suspension period when the operation mode is a yield thread, the number of cycles to be stored may be smaller than a suspension period in the case of a priority thread.

The instruction issuance suspending unit suspends issuing the instruction subsequent to specific instruction for a period as long as the number of cycles based on the detected operation mode.

This enables the performance of the operational processing apparatus to be ensured in both of the cases where the thread is a priority thread and a yield thread.

### Ninth Embodiment

On an operational processing apparatus in a ninth embodiment, the number of instructions to be issued during an instruction synchronous execution mode can be set, so that the number of instructions to be issued can be controlled without generating a dummy instruction unnecessarily occupying an instruction slot.

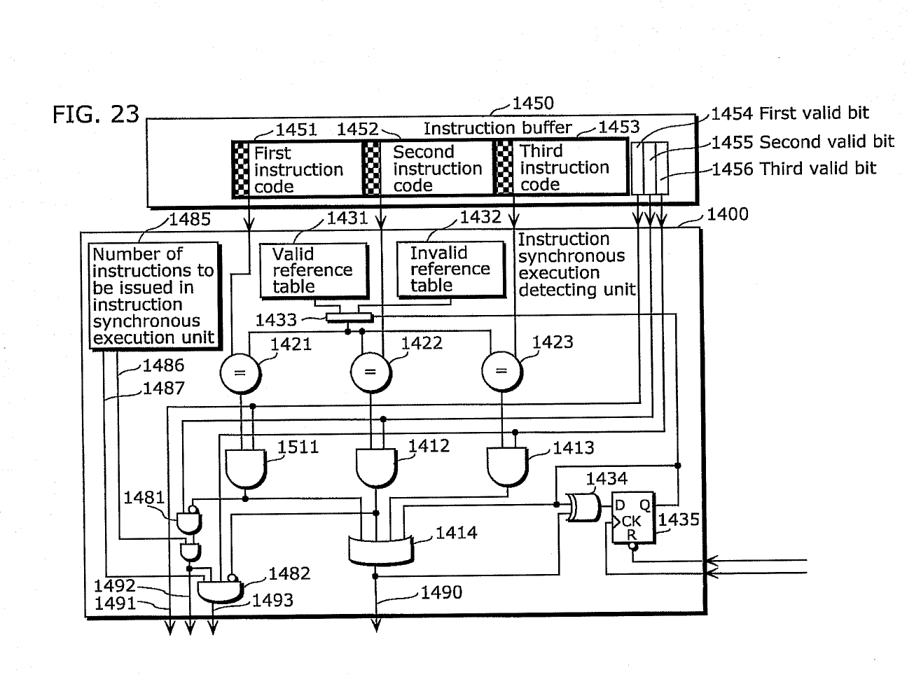

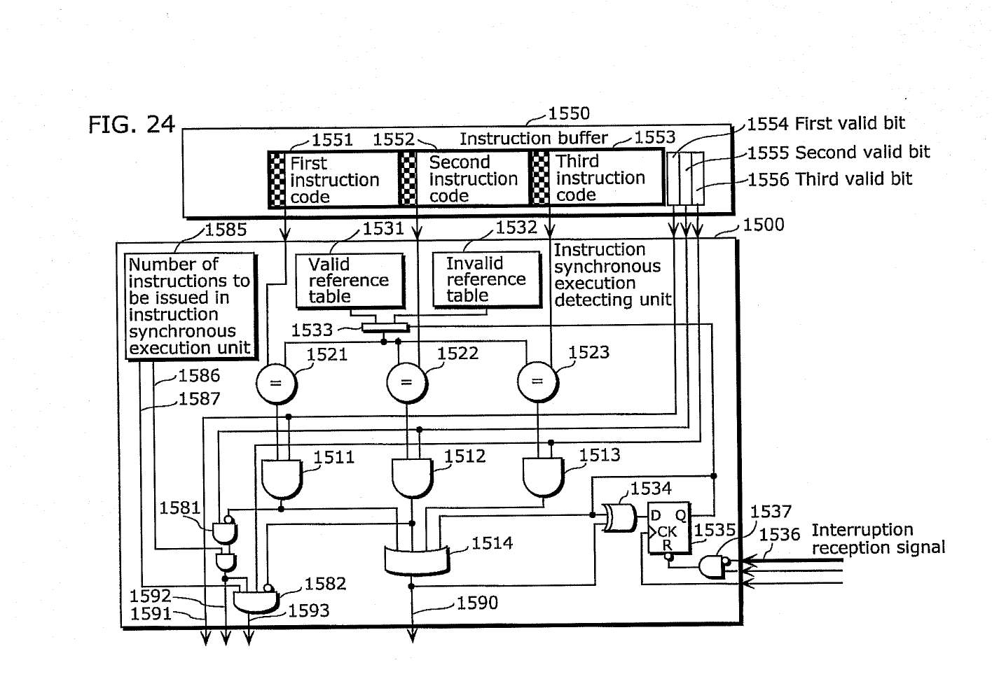

The embodiment shall be described, using FIGS. 23 and 24 corresponding to the improved circuit of FIGS. 3 and 4 shown in the first through the seventh embodiments.

FIG. 23 is a block diagram showing a structure for one thread in an internal structure of an instruction synchronous execution detecting unit in ninth embodiment. Compared with the instruction synchronous execution detecting unit in FIG. 3, the instruction synchronous execution detecting unit in FIG. 23 additionally includes a number of instructions to be issued in instruction synchronous execution unit 1485.

The number of instructions to be issued in instruction synchronous execution unit 1485 stores the number of issueable instructions during an instruction synchronous execution mode, and counts down each of the instructions when issued. This can improve processing efficiency of a thread since an effective instruction other than a dummy instruction, such as a nop, can be issued during the instruction synchronous execution mode.

### Tenth Embodiment

The shortest time of an actual time can be guaranteed, using the above described instruction synchronization detecting units; meanwhile, some codes can perform processing in advance in a C language program. A program can be inserted by inserting a pragma into a C source. When a compiler detects the codes in a process of compiler processing, the codes, of which thread can be processed in advance in an instruction synchronization executing mode, can be carried forward. Thus, performing of a similar processing can be supported by inputting the codes instead of instruction for instruction synchronization.

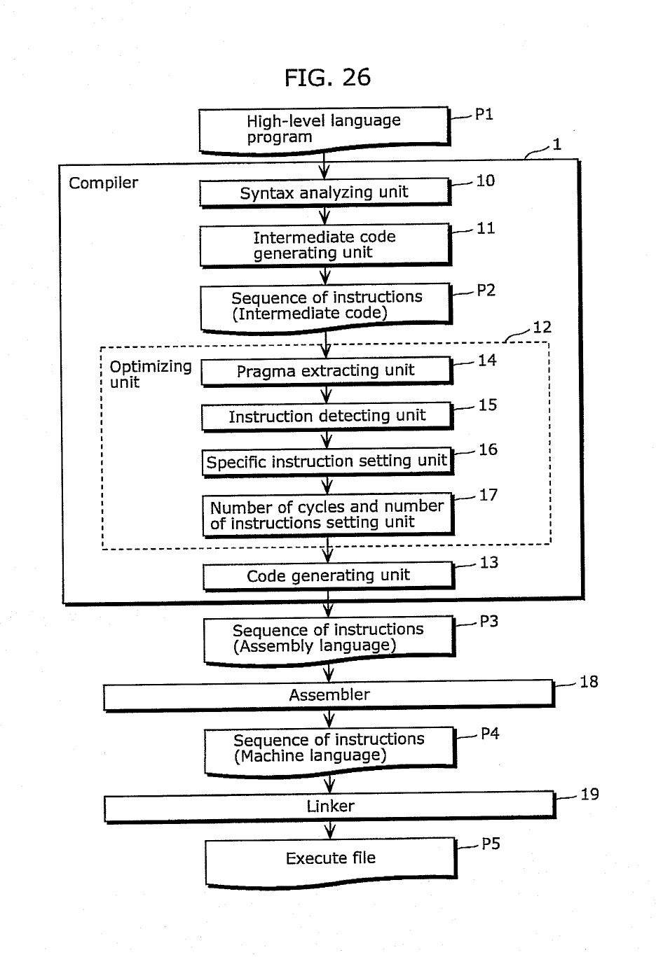

FIG. 26 is a block diagram showing a structure of a program converting apparatus in a tenth embodiment. The program converting apparatus in FIG. 26 includes a compiler 1, an assembler 18, and a linker 19. The compiler 1 includes a syntax analyzing unit 10, an intermediate code generating unit 11, an optimizing unit 12, and a code generating unit 13. The program converting apparatus in FIG. 26 is implemented by executing software achieving each of functional blocks on a computer.

The compiler 1 compiles a program written in a high-level language into an assembly language program. The high-level language program is, for example, the C language.

The syntax analyzing unit 10 analyzes a syntax of a high-level language program P1, such as the C language. The intermediate code generating unit 11 generates a sequence of instructions for an intermediate code P2 in which the high-level language program P1 is replaced with description of an intermediate instruction (referred to as instruction, hereinafter).

The optimizing unit 12 performs optimization processing on the sequence of instructions for an intermediate code P2 including a specific instruction for a synchronous execution. Hence, the optimizing unit 12 includes a pragma extracting unit 14, an instruction detecting unit 15, a specific instruction setting unit 16, and a number of cycles and number of instructions setting unit 17.

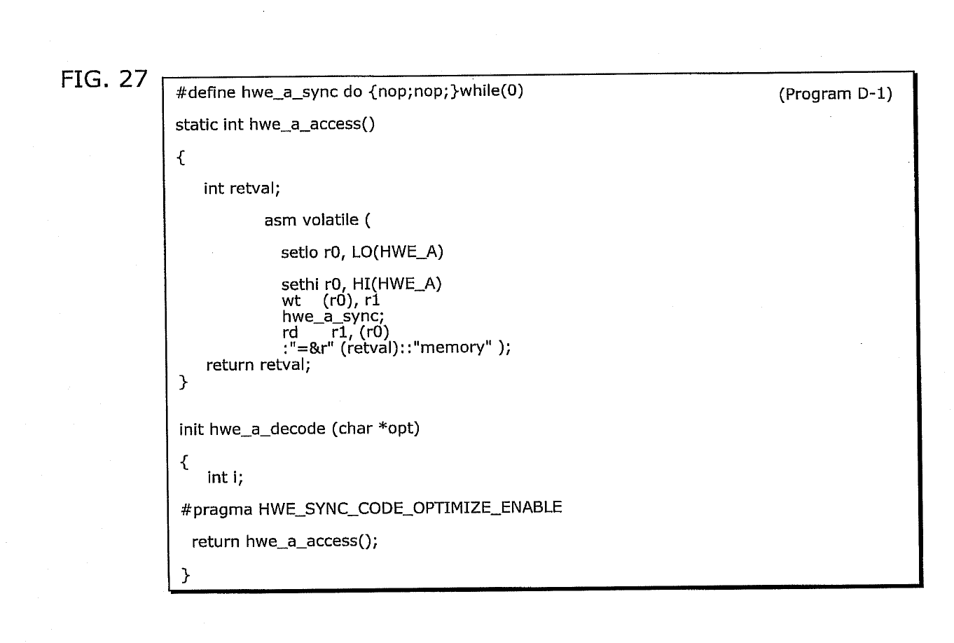

The pragma extracting unit 14 extracts, from a program having the sequence of instructions for an intermediate code P2, a directive (pragma) on a specific instruction to the program converting apparatus. FIG. 27 exemplifies the program. For convenience of description, a program D-1 shown in FIG. 27 exemplifies, not an intermediate code, but a high-level language program including a program written partially in an assembly language. The third line from the bottom starting with “#pragma” is the directive (pragma) on the specific instruction. Moreover, two nop instructions defined in the first line are inserted between the wt instruction in the eighth line and the rd instruction in the tenth line. The two nop instructions become two groups of instructions as the specific instruction since being the instruction synchronization executing mode.

According to the directive, the instruction detecting unit 15 detects, from the program having the sequence of instructions for an intermediate code P2, a first instruction (wt instruction) writing a processing request into an external apparatus, a second instruction (rd instruction) reading a response from the external apparatus, and the specific instruction. In FIG. 27, the wt instruction is detected as the first and the specific instruction, the rd instruction is detected as the second instruction. Further, the two instructions inserted into the eighth line are detected as the specific instructions.

In the case where there is a replaceable instruction, having as many cycles as the nop instruction, which succeeds the second instruction (rd instruction), the specific instruction setting unit 16 generates a second program by, between the first and the second instruction, carrying the instruction succeeding the second instruction, and replacing the nop instruction with the instruction.

The number of cycles and number of instructions setting unit 17 inserts, into the sequence of instructions for an intermediate code P2, an instruction setting the number of suspending cycles on the suspension period storing units shown in FIGS. 21 and 22, and an instruction setting the number of instructions on the number of instructions to be issued in instruction synchronous execution units shown in FIGS. 23 and 24.

The code generating unit 13 generates a sequence of instructions in an assembly language (a sequence of instructions in a mnemonic) out of the sequence of instructions for an intermediate code P2 with the above instructions added by the optimizing unit 12. The assembler 18 converts the sequence of instructions in an assembly language into a sequence of instructions in a machine language. The linker 19 links plural sequences of instructions in a machine language to generate an execute file.

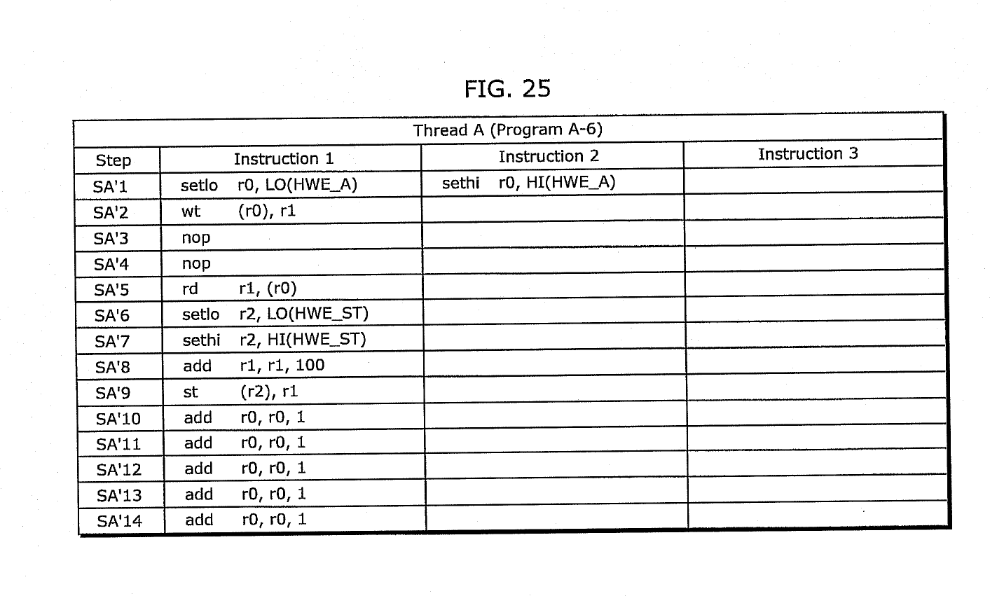

FIG. 25 exemplifies an unoptimized program A-6, and FIG. 18 exemplifies an optimized program A-5. Comparing FIGS. 25 and 18, as shown in SA′3 and SA′4 in FIG. 18, the optimization replaces the two nop instructions with the setlo instruction and the sethi instruction. This enables the processing efficiency of the program in FIG. 19 to improve.

It is noted that the program converting apparatus in the fourth embodiment inserts the above instructions into the sequence of instructions for an intermediate code P2 in the compiler. Instead, the program converting apparatus may be structured to insert: (A) a program statement (such as a function) suitable for the above instructions into the high-level language program P1; (B) a mnemonic instruction suitable for the above instructions into the sequence of instructions in an assembly language; or (C) a machine language instruction suitable for the above instructions into the sequence of instructions into a machine language.

It is noted that each of the above embodiments is described on an SMT-executable processor; instead, the above embodiments may be applied to a VLIW processor.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The instruction synchronous execution detecting unit, the instruction issuance suspending unit and the number of instructions to be issued in instruction synchronous execution unit in the present invention are effective for utilizing as a synchronization scheme of an instruction execution cycle on a multi-threaded processor system, and can guarantee an instruction execution cycle by a granularity period (cycle) utilizing logical OR for controlling the instruction issuing unit without changing a basic controlling structure.

What is claimed is:

1. An operational processing apparatus which can execute instructions in a same cycle, said operational processing apparatus comprising:
an instruction fetching unit configured to fetch instruction codes;
an instruction issuing unit configured to divide the instruction codes fetched by said instruction fetching unit into at least one instruction group which includes one or more simultaneously issueable instruction codes, and issue one or more instruction codes in the at least one instruction group;
an instruction decoding unit configured to decode the one or more instruction codes issued by said instruction issuing unit, and generate control signals required for operation; and
an operation processing unit configured to perform operation according to the control signals generated by said instruction decoding unit,
wherein said instruction issuing unit includes:
a detecting unit configured to detect a specific instruction instructing to suspend issuing instruction codes subsequent to the specific instruction during a predetermined period of cycles immediately after the specific instruction is issued; and
an instruction issuance suspending unit configured to suspend issuing of the instruction codes subsequent to the specific instruction during the predetermined period immediately after the specific instruction is issued.

2. The operational processing apparatus according to claim 1,
wherein, in the case where the specific instruction is detected, said instruction issuing unit is configured to exclude instruction codes subsequent to the specific instruction out of an instruction group including the specific instruction.

3. The operational processing apparatus according to claim 2,
wherein said instruction fetching unit is configured to fetch instruction codes for each of a plurality of threads and
said instruction issuing unit is configured to divide fetched to instruction codes into instruction groups for each of the plurality of threads.

4. The operational processing apparatus according to claim 2,
wherein said detecting unit is configured to detect the specific is instruction by a one-bit instruction bit field included in each of instruction codes.

5. The operational processing apparatus according to claim 2,
wherein said detecting unit is configured to detect the specific instruction by decoding an instruction bit field having bits included in each of instruction codes.

6. The operational processing apparatus according to claim 2,
wherein said detecting unit is configured to detect first and second instructions by decoding an instruction bit field having bits included in each of instruction codes, and detect each of instructions between the first instruction and an instruction immediately before the second instruction as the specific instruction.

7. The operational processing apparatus according to claim 6,
wherein the first instruction is for writing a processing request into an external apparatus, and the second instruction is for reading a response from the external apparatus.

8. The operational processing apparatus according to claim 6, further comprising
a processor state register which holds a state signal showing that issuing of the instruction codes subsequent to the specific instruction is currently suspended.

9. The operational processing apparatus according to claim 6, further comprising
a holding unit which holds a state signal showing that the operational processing apparatus is in the predetermined period of cycles immediately after issuing of the specific instruction, and issuing of the instruction subsequent to the specific instruction is currently suspended,
wherein said detecting unit is configured to enable the state signal when detecting the first instruction, and to disable the state signal when detecting the second instruction.

10. The operational processing apparatus according to claim 9,
wherein said holding unit is configured to disable the state signal held in said holding unit when interruption processing is occurred.

11. The operational processing apparatus according to claim 1,
wherein the specific instruction is subsequent to an instruction requesting, to perform processing, an external apparatus connected to said operational processing apparatus.

12. The operational processing apparatus according to claim 1,
wherein said instruction issuance suspending unit includes a number of cycles storing unit configured to store the number of cycles showing the predetermined period of cycles, and
said operational processing apparatus is configured to suspend issuing the instruction subsequent to the specific instruction as long as a period of the number of the stored cycles.

13. The operational processing apparatus according to claim 12,
wherein said number of cycles storing unit is configured to store the number of cycles corresponding to operating frequency of said operational processing apparatus.

14. The operational processing apparatus according to claim 12,
wherein said number of cycles storing unit is configured to store the numbers of cycles corresponding to each of operating frequencies on which said operational processing apparatus can be operated.

15. The operational processing apparatus according to claim 1,
wherein said instruction issuing unit includes an operation mode detecting unit configured to detect whether or not the operational processing apparatus is in a prioritized operation mode in which a thread to which the specific instruction belongs has priority over another thread, and
said instruction issuance suspending unit is configured to suspend issuing the instruction subsequent to the specific instruction, based on the detected operation mode, as long as the predetermined period of cycles.

16. The operational processing apparatus according to claim 1,
wherein said instruction issuing unit includes:
an operation mode detecting unit configured to detect whether or not the operational processing apparatus is in an operation mode in which a thread to which the specific instruction belongs has priority over another thread; and
a number of cycles storing unit configured to store the number of cycles showing the predetermined period of cycles for each of operating modes, and
said instruction issuance suspending unit is configured to suspend issuing the instruction subsequent to the specific instruction as long as a period corresponding to the number of cycles based on the detected operation mode.

17. The operational processing apparatus according to claim 6,
wherein said instruction issuing unit includes a number of instruction storing unit configured to store the number of issueable instructions between the first and the second instructions, and count down the number for each issuance of an instruction.

18. The operational processing apparatus according to claim 10, further comprising
a processor state register which holds a value of the state signal held in said holding unit,
wherein said instruction issuance suspending unit includes a number of instructions storing unit configured to store the number of issueable instructions between the first and the second instructions, and count down for each issuance of an instruction when said holding unit holds the state signal showing that the issuance of the instruction subsequent to the specific instruction is currently suspended.

19. A processor which simultaneously issues and executes instructions including instruction groups having a simultaneously issueable instruction,
wherein said processor executes a program including a specific instruction, and
the specific instruction instructs to exclude an instruction subsequent to the specific instruction out of the instruction groups including the specific instruction, and to suspend issuing the instruction subsequent to the specific instruction only during a predetermined period immediately after the specific instruction is issued.

20. The processor according to claim 19,
wherein said processor is a multi-thread processor fetching threads, and dividing a sequence of instructions into the instruction groups for each of threads.

21. A program converting apparatus which converts a first program into a second program, said program converting apparatus comprising:
an extracting unit configured to extract, from the first program, a directive directing said program converting apparatus setting of a specific instruction;
a detecting unit configured to detect, according to the directive in the first program, a first instruction requesting an external apparatus to perform processing, and second instruction reading a response from the external apparatus; and
a generating unit configured to generate the second program by setting the specific instruction between the first and the second instructions,
wherein the specific instruction instructs to exclude an instruction subsequent to the specific instruction out of an instruction group including the specific instruction, and to suspend issuing the instruction subsequent to the specific instruction only during a predetermined period immediately after the specific instruction is issued.

22. A computer-readable program product for use with a program converting apparatus which converts a first program into a second program, said computer-readable program product, when loaded into a computer, causing a computer to execute:
extracting, from the first program, a directive on a specific instruction to the program converting apparatus;
detecting, in the first program, a first instruction writing a processing request into an external apparatus, and a second instruction reading a response from the external apparatus; and
generating the second program by carrying to dispose an instruction succeeding the second instruction between the first and the second instructions,
wherein the specific instruction instructs to exclude an instruction subsequent to the specific instruction out of an instruction group including the specific instruction, and to suspend issuing the instruction subsequent to the specific instruction only during a predetermined period immediately after the specific instruction is issued.
